(19) United States
(12) Patent Application Publication
(10) Pub. No.: US 2023/0142417 A1
(43) Pub. Date: May 11, 2023

(54) DISPLAY DEVICES WITH TILED COMPONENTS

(71) Applicant: Corning Incorporated, Corning, NY (US)

(72) Inventors: Kirk Richard Allen, Elmira, NY (US); Guanglei Du, Pittsford, NY (US); Tomohiro Ishikawa, Corning, NY (US); Mark Francis Krol, Corning, NY (US); Dmitri Vladislavovich Kuksenkov, Elmira, NY (US); Shenping Li, Painted Post, NY (US); Ying Li, Painted Post, NY (US); Xiang-Dong Mi, Pittsford, NY (US); Horst Herbert Anton Schreiber, Livonia, NY (US); Andrii Varanytsia, Sunnyvale, CA (US)

(21) Appl. No.: 17/920,518

(22) PCT Filed: Apr. 14, 2021
(86) PCT No.: PCT/US2021/027173

§ 371 Date: Oct. 21, 2022

Related U.S. Application Data
(60) Provisional application No. 63/017,078, filed on Apr. 29, 2020.

(51) Int. Cl. G02F 1/13357

(52) U.S. Cl. CPC G02F 1/133603; G02F 1/133605; G02F 1/133611

(57) ABSTRACT

Display devices are disclosed including tiled components. The tiled components can include any one or more of tiled light board assemblies, tiled diffusers, and tiles patterned light guides. In some embodiments, entire backlight units may be tiled.

### CROSS-REFERENCE TO RELATED APPLICATIONS

This application claims the benefit of priority under 35 U.S.C. § 371 of International Application Serial No.: PCT/US2021/027173, filed on Apr. 14, 2021, which claims the benefit of priority under 35 U.S.C. § 119 of U.S. Provisional Application Ser. No. 63/017,078 filed on Apr. 29, 2020, the contents of which are relied upon and incorporated herein by reference in their entirety.

### FIELD

The present disclosure is directed to a display device, and in particular a display device comprising tiled components such as tiled backlight and associated subassemblies.

### BACKGROUND

To remain competitive with organic light emitting diode (OLED) displays and other emerging display technologies, liquid crystal displays (LCD) follow general trends of increasing resolution, greater peak brightness and dynamic range (HDR), greater contrast, thinner set design, and narrower bezels. The demands of increased peak brightness and contrast can currently only be met using so-called direct-lit backlights comprising a 2-dimensional (2D) array of light sources directly behind the LCD panel relative to a viewer. The challenge is to also achieve reduced set thickness, because the light generated by the 2D array of small-size light sources must be distributed in a plane to produce a uniform illumination of the display panel, and this is more difficult to do in a limited vertical (thickness) space.

Recent display designs achieve a reduced thickness utilizing carrier plates with engineered printed patterns of reflective and light extracting features printed on the surface(s). Implementing these designs in the mass production of liquid crystal displays requires accurate alignment between the array of light sources and the printed pattern. The challenge to align printed patterns with light sources becomes harder as the size of the display grows, and high-end TV sets at present can be 140-centimeters diagonal, 165-centimeters diagonal, 178-centimeters diagonal, 203-centimeters diagonal, or larger.

Therefore, a need exists for novel, thin, direct-lit backlight designs that can provide component alignment accuracy and uniform light output.

### SUMMARY

Liquid crystal displays are commonly used in various electronics, such as cell phones, laptops, electronic tablets, televisions, and computer monitors. Liquid crystal displays are light valve-based displays in which the display panel includes an array of individually addressable light valves. Liquid crystal displays may include a backlight for producing light that may then be wavelength converted, filtered, and/or polarized to produce an image from the LCD panel. Backlights may be edge-lit or direct-lit. Edge-lit backlights may include a light emitting diode (LED) array edge-coupled to a light guide plate that emits light from its surface. Direct-lit backlights may include a two-dimensional (2D) array of LEDs behind the LCD panel.

As display device size (display panel diagonal corner-to-corner dimension) increases, requirements for alignment accuracy between light reflection and extraction features present in a backlight unit, for example features deposited on a light guide plate or other carrier plate, become difficult to achieve, and can be more easily upset due to differences in component expansion or contraction during temperature excursions.

Direct-lighted backlights may have the advantage of improved dynamic contrast as compared to edge-lighted backlights. For example, a display with a direct-lighted backlight may independently adjust the brightness of each LED to set the dynamic range of the brightness across the image. This is commonly known as local dimming. To achieve desired light uniformity and/or avoid hot spots in direct-lighted backlights, however, a diffuser plate or film may be positioned at a distance from the LEDs, thus making the overall display thickness greater than that of an edge-lighted backlight. Lenses positioned over the LEDs have been used to improve the lateral spread of light in direct-lighted backlights. However, the optical distance (OD) between the LEDs and the diffuser plate or film in such configurations (e.g., from at least 10 millimeters to typically about 20-30 millimeters), may still result in an undesirably high overall display thickness and/or these configurations may produce undesirable optical losses as the backlight thickness is decreased.

To overcome these obstacles, backlight units arranged in smaller, tiled configurations are described, wherein dimensional tolerances can be more easily met by piecemeal assembly of a display backlight unit compared to attempting to meet such requirements with a single, large assembly. As used herein, the term “tiled” refers to the side-by-side (edge-to-edge) arrangement of multiple backlight subassemblies to produce a single, larger backlight unit. For example, a single backlight unit comprising a surface area of 1000 square centimeters can be assembled using twenty 50-square-centimeter light boards arranged side-by-side. The ability to manufacture such smaller-sized light boards to the needed dimensional alignment noted above is much easier than attempting to meet such requirement with a single, 1000 square centimeter light board.

However, tiling may also result in a visible seam or gap between neighboring LED light boards. Moreover, edges of an LED light board (e.g., printed circuit board) may have surface or geometrical properties different from the middle of the board. Therefore, the seams of two neighboring LED boards can trap light or reflect light originating from LED chips. Another potential visual defect related to a seam line between neighboring LED boards is a slightly different pitch between LED chips across the seam. As a result, a seam between two LED boards may create a defect line visible through a complete stack of patterned diffuser or other volume diffuser and optical films. Such seam lines may be visible as a “cold” line characterized by local drop of luminance, or as a “hot” line characterized by a local increase of luminance, or a blue color line characterized by a local decrease of a Color y component of CIE color chromaticity coordinates, or by yellow line characterized by a local increase of a Color y component of CIE color chromaticity coordinates.

Visibility of a seam line between neighboring light boards is unacceptable in practical applications.

Accordingly, in some embodiments, a display device is disclosed, comprising a display panel and a backlight unit arranged adjacent the display panel. The backlight unit can comprise a first light board assembly comprising a first plurality of light sources and a second light board assembly arranged adjacent to and on a common plane with the first light board assembly, the second light board assembly comprising a second plurality of light sources. The display device may further comprise a diffuser positioned over the first light board assembly and the second light board assembly, the diffuser comprising a plurality of patterned reflectors on a surface thereof.

The first plurality of light sources can comprise a first plurality of perimeter light sources located proximate to and along a perimeter of the first light board assembly and a first plurality of interior light sources positioned interior to the first plurality of perimeter light sources. The second plurality of light sources can comprise a second plurality of perimeter light sources located proximate to and along a perimeter of the second light board assembly and a second plurality of interior light sources located interior to the second plurality of perimeter light sources, the plurality of patterned reflectors comprising a first subset of patterned reflectors aligned with corresponding light sources of the first plurality of perimeter light sources and a second subset of patterned reflectors aligned with corresponding light sources of the first plurality of interior light sources. In embodiments, the first subset of patterned reflectors can be different from the second subset of patterned reflectors.

In some embodiments, the plurality of patterned reflectors can comprise a third subset of patterned reflectors aligned with corresponding light sources of the second plurality of perimeter light sources and a fourth subset of patterned reflectors aligned with corresponding light sources of the second plurality of interior light sources. The third subset of patterned reflectors can be different from the fourth subset of patterned reflectors.

A pitch P1 between the first plurality of perimeter light sources and the first plurality of interior light sources can be equal to the pitch P2 between the second plurality of perimeter light sources and the second plurality of interior light sources. A pitch P3 between the first plurality of perimeter light sources and the second plurality of perimeter light sources can be different from P1.

In some embodiments, the first light board assembly can comprise a first light board substrate and the second light board assembly can comprise a second light board substrate, the first light board substrate comprising a first front surface and a first edge surface and the second light board substrate comprising a second front surface and a second edge surface adjacent to and spaced apart from the first edge surface by a gap. The display device may further comprise a reflective material disposed across the gap. The reflective material may further be disposed on the first and second front surfaces, for example on at least a portion of the first and second front surfaces.

In some embodiments, each of the first front surface and the second front surface can comprise a reflective layer and the reflective material can be disposed over the reflective layer.

The first light board assembly can comprise a first light board substrate and the second light board assembly can comprise a second light board substrate, the first light board substrate comprising a first back surface and a first edge surface and the second light board substrate comprising a second back surface and a second edge surface adjacent to and spaced apart from the first edge surface by a gap, the display device further comprising a reflective material disposed across the gap. For example, in some embodiments, the reflective material may be disposed on at least one of the first back surface or the second back surface.

In some embodiments, the first and second light board assemblies can be coupled to a back frame, the display device further comprising a reflective material positioned between the back frame and the first and second light board assemblies.

In various embodiments, a reflective material can be disposed in and at least partially filling a gap between the first light board assembly and the second light board assembly. In some embodiments, a transparent coating can be disposed on the reflective material.

The diffuser can comprise a carrier plate comprising a first surface and a second surface opposite the first surface, the second surface facing the light sources. The first and second pluralities of patterned reflectors can be located on at least one of the first surface of the carrier plate or the second surface of the carrier plate. In some embodiments, the diffuser may further comprise a diffusive layer on the opposite one of the first surface of the carrier plate or the second surface the carrier plate.

In some embodiments, the first light board assembly can comprise a first light board substrate, wherein a CTE of the carrier plate and a CTE of the first light board substrate do not differ by more than 3.0×10⁻⁶/° C.

In some embodiments, the second light board assembly can comprise a second light board substrate, wherein a CTE of the carrier plate and a CTE of the second light board substrate do not differ by more than 3.0×10′/° C.

In some embodiments, a first half of each of the first subset of patterned reflectors can be different from a second half of each of the first subset of patterned reflectors.

In some embodiments, a first half of each of the first subset of patterned reflectors can be the same as a second half of each of the first subset of patterned reflectors.

The first light board assembly can comprise a first light board substrate with a first edge surface and the second light board assembly can comprise a second light board substrate with a second edge surface adjacent to and facing the first edge surface, the first edge surface comprising a first chamfer with a first chamfer height Ch1 and a second chamfer with a second chamfer height Ch2, the second chamfer opposite the first chamfer. In some embodiments, the first and second chamfers can be asymmetric relative to a central plane of the first light board substrate.

In some embodiments, at least one of the first chamfer or the second chamfer can comprise a curvature, for example a convex curvature.

The second edge surface of the second light board substrate can be separated from the first edge surface of the first light board substrate by a gap G, and at least one of Ch1 or Ch2 can be less than 0.5G.

The first light board assembly can comprise a first light board substrate comprising a first front surface and a first back surface opposite the first front surface, the first back surface of the first light board substrate coupled to a first surface of a support frame, the first front surface comprising a first surface reflectivity Rg and the first surface of the support frame comprising a second surface reflectivity Rb in a range from about 0.5Rg to about 1.5Rg.

The first light board assembly can comprise a first light board substrate comprising a first front surface and a first back surface opposite the first front surface, the first back surface coupled to a first surface of a support frame, the first front surface comprising a first surface scattering factor σg and the first surface of the support frame comprising a second surface scattering factor σb in a range from about 0.5σg to about 1.5σg.

In some embodiments, the first light board assembly can comprise a first light board substrate comprising a first front surface and a first back surface opposite the first front surface, the first back surface of the first light board substrate coupled to a first surface of a support frame, and wherein the first front surface comprises a surface scattering factor σg greater than about 1°.

In some embodiments, σg can be greater than about 1.3°. In some embodiments, σg can be greater than about 2°.

In some embodiments, the backlight unit comprises a first backlight module, the display device comprising a second backlight module adjacent to and on a common plane with the first backlight module.

In other embodiments, a display device is described, comprising a display panel and a backlight unit arranged adjacent the display panel. The backlight unit can comprise a light board assembly comprising a plurality of light sources and a diffuser positioned between the light board assembly and the display panel, the diffuser comprising a first patterned reflector plate and a second patterned reflector plate adjacent to and on a common plane with the first patterned reflector plate, and a diffuser plate positioned between the first patterned reflector plate and the second patterned reflector plate and the display panel, the first patterned reflector plate comprising a first plurality of patterned reflectors and the second patterned reflector plate comprising a second plurality of patterned reflectors.

The diffuser plate can comprise a first carrier plate with a first diffusing layer disposed over a surface thereof.

In some embodiments, each of the first and second patterned reflector plates can comprise a second carrier plate and a second diffusing layer disposed on a surface thereof opposite the first plurality of patterned reflectors and the second plurality of patterned reflectors, respectively.

The first patterned reflector plate and the second patterned reflector plates can be bonded together at adjacent edge surfaces thereof with an index-matching material, for example an epoxy index matched to the first and second patterned reflector plates.

In some embodiments, each second carrier plate can be transparent.

In still other embodiments, a display device is disclosed, comprising a display panel and a first backlight module comprising a first light board assembly and a first diffuser, the first light board assembly comprising a first plurality of light sources. The display device may further comprise a second backlight module comprising a second light board assembly and a second diffuser, the second light board assembly comprising a second plurality of light sources, the second backlight module adjacent to and on a common plane with the first backlight module. The first diffuser can comprise a first patterned reflector plate comprising a first plurality of patterned reflectors and the second diffuser can comprise a second patterned reflector plate comprising a second plurality of patterned reflectors.

The first plurality of light sources can comprise a first plurality of perimeter light sources located proximate to and along a perimeter of the first light board assembly and a first plurality of interior light sources positioned interior to the first plurality of perimeter light sources and the second plurality of light sources comprises a second plurality of perimeter light sources located proximate to and along a perimeter of the second light board assembly and a second plurality of interior light sources located interior to the second plurality of perimeter light sources. The first plurality of patterned reflectors can comprise a first subset of patterned reflectors aligned with corresponding light sources of the first plurality of perimeter light sources and a second subset of patterned reflectors aligned with corresponding light sources of the first plurality of interior light sources, and wherein the first subset of patterned reflectors is different from the second subset of patterned reflectors.

In some embodiments, the second plurality of patterned reflectors can comprise a third subset of patterned reflectors aligned with corresponding light sources of the second plurality of perimeter light sources and a fourth subset of patterned reflectors aligned with corresponding light sources of the second plurality of interior light sources, and wherein the third subset of patterned reflectors is different from the fourth subset of patterned reflectors.

In some embodiments, a pitch P1 between the first plurality of perimeter light sources and the first plurality of interior light sources can be equal to the pitch P2 between the second plurality of perimeter light sources and the second plurality of interior light sources.

In some embodiments, a pitch P3 between the first plurality of perimeter light sources and the second plurality of perimeter light sources can be different from P1.

The first light board assembly can comprise a first light board substrate and the second light board assembly can comprise a second light board substrate. The first light board substrate can comprise a first front surface and a first edge surface, and the second light board substrate can comprise a second front surface and a second edge surface adjacent to and spaced apart from the first edge surface by a gap. The display device may further comprise a reflective material disposed across the gap between the first and second light board substrates. The reflective material can be further disposed on at least one of the first front surface or the second front surface.

Each of the first front surface and the second front surface can comprise a reflective layer.

In some embodiments, the first light board assembly can comprise a first light board substrate and the second light board assembly can comprise a second light board substrate, the first light board substrate comprising a first back surface and a first edge surface, and the second light board substrate comprising a second back surface and a second edge surface adjacent to and spaced apart from the first edge surface by a gap. The display device may further comprise a reflective material disposed across the gap between the first light board substrate and the second light board substrate. The reflective material may be further disposed, for example, on the first and second back surfaces.

The first and second backlight modules can be coupled to a back frame, and in some embodiments, the display device may further comprise a reflective material positioned between the back frame and the first and second backlight modules.

In some embodiments, a reflective material can be disposed in and at least partially filling the gap between the first and second edge surfaces. A transparent coating can be disposed on the reflective material.

The first diffuser can comprise a first carrier plate comprising a first surface and a second surface opposite the first surface, the second surface facing the light sources. The first plurality of patterned reflectors can be located on a surface of the first carrier plate, for example the second surface.

In some embodiments, the first diffuser may further comprise a first diffusive layer on the first carrier plate, for example the first surface of the first carrier plate.

In some embodiments, the first light board assembly can comprise a first light board substrate, wherein a CTE of the first carrier and a CTE of the first light board substrate do not differ by more than 3.0×10⁻⁶/° C.

In some embodiments, the second light board assembly can comprise a second light board substrate and the second diffuser can comprise a second carrier, wherein a CTE of the second carrier and a CTE of the second light board substrate do not differ by more than 3.0×10⁻⁶1° C.

A first half of each of the first subset of patterned reflectors can be different from a second half of each of the first subset of patterned reflectors. However, in other embodiments, a first half of each of the first subset of patterned reflectors can be the same as a second half of each of the first subset of patterned reflectors.

In some embodiments, the first light board assembly can comprise a first light board substrate with a first edge surface and the second light board assembly can comprise a second light board substrate with a second edge surface adjacent to and facing the first edge surface, the first edge surface comprising a first chamfer with a first chamfer height Ch1 and a second chamfer with a second chamfer height Ch2, the second chamfer opposite the first chamfer.

In some embodiments, the first and second chamfers can be asymmetric relative to a central plane of the first light board substrate. That is, Ch1 may not be equal to Ch2.

In some embodiments, at least one of the first chamfer or the second chamfer can comprise a curvature, for example a convex curvature.

The second edge surface of the second light board substrate can be separated from the first edge surface of the first light board substrate by a gap G, wherein at least one of Ch1 or Ch2 can be less than 0.5G.

The first light board assembly can comprise a first light board substrate comprising a first front surface and a first back surface opposite the first front surface, the first back surface of the first light board substrate coupled to a first surface of a support frame, the first front surface comprising a first surface reflectivity Rg and the first surface of the support frame comprising a second surface reflectivity Rb in a range from about 0.5Rg to about 1.5Rg.

The first light board assembly can comprise a first light board substrate comprising a first front surface and a first back surface opposite the first front surface, the first back surface coupled to a first surface of a support frame, the first front surface comprising a first surface scattering factor σg and the first surface of the support frame comprising a second surface scattering factor σb in a range from about 0.5σg to about 1.5σg.

In some embodiments, the first light board assembly can comprise a first light board substrate comprising a first, front surface and a second surface opposite the front surface, the second surface of the light board substrate coupled to a first surface of a support frame, the front surface comprising a surface scattering factor σg greater than about 1°, for example greater than about 1.3°, such as greater than about 2°.

In some embodiments, the first front surface can comprise a reflective layer.

In still other embodiments, a display device is disclosed, comprising a display panel, a first backlight module arranged adjacent the display panel, the first backlight module comprising a first light board assembly comprising a first plurality of light sources. The display device may further comprise a first patterned light guide plate comprising a first plurality of patterned reflectors and a second patterned light guide plate comprising a second plurality of patterned reflectors, and a first diffuser positioned between the first and second patterned light guide plates and the display panel, the first diffuser comprising a first diffuser plate and a first diffusive layer. The display device may still further comprise a second backlight module arranged adjacent to and on a common plane with the first backlight module and spaced apart from the first backlight module, the second backlight module comprising a second light board assembly comprising a second plurality of light sources, and a third patterned light guide plate comprising a third plurality of patterned reflectors and a fourth patterned light guide plate comprising a fourth plurality of patterned reflectors. The display device may also include a second diffuser positioned between the third and fourth patterned light guide plates and the display panel, the second diffuser comprising a second diffuser plate and a second diffusive layer. The first backlight module and the second backlight module can be coupled to a support frame.

In some embodiments, the first, second, third, and fourth patterned light guide plates can comprise third, fourth, fifth, and sixth diffusive layers, respectively.

In other embodiments, a display device is described, comprising a display panel and a backlight unit arranged adjacent the display panel. The backlight unit can comprise a first light board assembly comprising a first plurality of light sources and a first patterned light guide plate bonded to the first plurality of light sources, the first patterned light guide plate comprising a first plurality of patterned reflectors disposed on a surface thereof, the first plurality of patterned reflectors aligned with corresponding light sources of the first plurality of light sources. The backlight unit may still further comprise a first diffuser positioned between the first light guide plate and the display panel, the first diffuser comprising one or more image-enhancing films and a first diffuser plate.

The display device may further comprise a second diffuser plate adjacent to and on a common plane with the first diffuser plate.

The first light board assembly can comprise a second plurality of light sources, the display device further comprising a second patterned light guide plate bonded to the second plurality of light sources, the second patterned light guide plate comprising a second plurality of patterned reflectors disposed on a surface thereof.

The display device may further comprise a second diffuser plate adjacent to and on a common plane with the first diffuser plate.

The display device may further comprise a second light board assembly comprising a second plurality of light sources, a second patterned light guide plate bonded to the second plurality of light sources, the second patterned light guide plate comprising a second plurality of patterned reflectors disposed on a surface thereof.

In some embodiments, the first light board assembly can comprise a first light board substrate with a first edge surface and a first front surface and the second light board assembly can comprise a second light board substrate with a second edge surface and a second front surface, the first edge surface and the second edge surface separated by a gap G, and wherein a reflective material is disposed across the gap. In some embodiments, the reflective material may also be disposed on at least one of the first front surface or the second front surface.

The first light board assembly can comprise a first light board substrate with a first edge surface and a first back surface and the second light board assembly can comprise a second light board substrate with a second edge surface and a second back surface, the first edge surface and the second edge surface separated by a gap G. A reflective material can be disposed across the gap. In some embodiments, the reflective material can be disposed on at least one of the first back surface or the second back surface.

In yet other embodiments, a display device is disclosed, comprising a display panel and a backlight unit arranged adjacent the display panel. The backlight unit can comprise a first light board assembly comprising a first plurality of light sources and a second light board assembly comprising a second plurality of light sources, the second light board assembly adjacent to and on a common plane with the first light board assembly. The backlight unit may further comprise a first light guide plate bonded to the first plurality of light sources and a second light guide plate bonded to the second plurality of light sources, the first light guide plate comprising a first plurality of patterned reflectors disposed on a surface thereof opposite the first plurality of light sources and the second light guide plate comprising a second plurality of patterned reflectors disposed on a surface thereof opposite the second plurality of light sources. The backlight unit may still further comprise a diffuser positioned between the light guide plate and the display panel, the diffuser comprising a diffuser plate.

In some embodiments, the first plurality of light sources can comprise a first plurality of perimeter light sources located proximate to and along a perimeter of the first light board assembly and a first plurality of interior light sources positioned interior to the perimeter light sources and the second plurality of light sources comprises a second plurality of perimeter light sources located proximate to and along a perimeter of the second light board assembly and a second plurality of interior light sources located interior to the second plurality of perimeter light sources. The first plurality of patterned reflectors can comprise a first subset of patterned reflectors aligned with corresponding light sources of the first plurality of perimeter light sources and a second subset of patterned reflectors aligned with corresponding light sources of the first plurality of interior light sources. In some embodiments, the first subset of patterned reflectors can be different from the second subset of patterned reflectors.

The second plurality of patterned reflectors can comprise a third subset of patterned reflectors aligned with corresponding light sources of the second plurality of perimeter light sources and a fourth subset of patterned reflectors aligned with corresponding light sources of the second plurality of interior light sources. The third subset of patterned reflectors can be different from the fourth subset of patterned reflectors.

In some embodiments, a pitch P1 between the first plurality of perimeter light sources and the first plurality of interior light sources can be equal to the pitch P2 between the second plurality of perimeter light sources and the second plurality of interior light sources.

In some embodiments, a pitch P3 between the first plurality of perimeter light sources and the second plurality of perimeter light sources can be different from P1.

The first light board assembly can comprise a first light board substrate and the second light board assembly can comprise a second light board substrate, the first light board substrate comprising a first front surface and a first edge surface and the second light board substrate comprising a second front surface and a second edge surface adjacent to and spaced apart from the first edge surface by a gap, the display device further comprising a reflective material disposed across the gap between the first and second light board substrates. The reflective material may be further disposed on at least one of the first front surface or the second front surface.

In some embodiments, each of the first front surface and the second front surface can comprise a reflective layer.

The first light board assembly can comprise a first light board substrate and the second light board assembly can comprise a second light board substrate, the first light board substrate comprising a first back surface and a first edge surface, and the second light board substrate comprising a second back surface and a second edge surface adjacent to and spaced apart from the first edge surface by a gap. The display device may further comprise a reflective material disposed across the gap between the first light board substrate and the second light board substrate. In some embodiments, the reflective material may also be disposed on at least one of the first back surface or the second back surface.

In some embodiments, the first light board assembly can comprise a first light board substrate with a first edge surface and the second light board assembly can comprise a second light board substrate with a second edge surface adjacent to and facing the first edge surface, the first edge surface comprising a first chamfer with a first chamfer height Ch1 and a second chamfer with a second chamfer height Ch2, the second chamfer opposite the first chamfer. In some embodiments, the first and second chamfers can be asymmetric relative to a central plane of the first light board substrate. That is, in some embodiments, Ch1 may not be equal to Ch2. In some embodiments, at least one of the first chamfer or the second chamfer comprises a curvature, for example a convex curvature. The second edge surface can be separated from the first edge surface by a gap G, wherein at least one of Ch1 or Ch2 is less than 0.5G.

The first light board assembly can comprise a first light board substrate comprising a front surface and a second surface opposite the front surface, the second surface of the light board substrate coupled to a first surface of a support frame, the front surface comprising a first surface reflectivity Rg and the first surface of the support frame comprising a second surface reflectivity Rb in a range from about 0.5Rg to about 1.5Rg.

The first light board assembly can comprise a first light board substrate comprising a first, front surface and a second surface opposite the front surface, the second surface of the light board substrate coupled to a first surface of a support frame, the front surface comprising a first surface scattering factor σg and the first surface of the support frame comprising a second surface scattering factor σb in a range from about 0.5σg to about 1.5σg.

The first light board assembly can comprise a first light board substrate comprising a front surface and a second surface opposite the front surface, the second surface of the light board substrate coupled to a first surface of a support frame, wherein the front surface comprises a surface scattering factor σg greater than about 1°, for example greater than about 1.3°, such as greater than about 2°.

In yet another embodiment, a display device is described, comprising a display panel and a backlight unit arranged adjacent the display panel. The backlight unit can comprise a light board assembly comprising a first plurality of light sources and a diffuser positioned between the light guide plate and the display panel. The diffuser can comprise a first diffuser plate and a second diffuser plate adjacent to and on a common plane with the first diffuser plate, the first diffuser plate comprising a first edge surface and the second diffuser plate comprising a second edge surface, the first diffuser plate comprising a first plurality of patterned reflectors disposed on a surface thereof and the second diffuser plate comprising a second plurality of patterned reflectors disposed on a surface thereof.

The first edge surface of the first diffuser plate can be bonded to the second edge surface of the second diffuser plate by an index-matching material matched to an index of refraction of the first and second diffuser plates.

Both the foregoing general description and the following detailed description present embodiments intended to provide an overview or framework for understanding the nature and character of the embodiments disclosed herein.

The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a cross-sectional side view (exploded) of an exemplary display device;

FIGS. 2-6 illustrate exemplary geometric patterns for arrays of light sources on a light board;

FIG. 7 is a top view of an exemplary light board showing a reflective layer over the light board and surrounding light sources on the light board;

FIG. 8 is a close-up view of a portion of the cross-section of FIG. 1;

FIG. 9 is a view of a bottom surface of a diffuser showing patterned reflectors arrayed on the surface of a carrier plate;

FIG. 10 depicts another configuration of another exemplary patterned reflector;

FIG. 11 is a cross-sectional view of an exemplary backlight unit comprising a plurality of light board modules according to embodiments of the present disclosure;

FIG. 12 is a top view of a light board module comprising perimeter light sources and interior light sources according to embodiments disclosed herein;

FIG. 13 is a top view of a plurality of the light board modules of FIG. 12 arranged edge-to-edge with a gap therebetween according to embodiments disclosed herein;

FIG. 14 is a schematic view of two adjacent patterned reflectors aligned with light sources having a pitch P1 therebetween;

FIG. 15 is a schematic view of two patterned reflectors adjacent to each other across a gap between adjacent light board modules having a pitch P3 therebetween, the patterned reflectors being circularly asymmetric such that a radial density profile of a portion of one of the patterned reflectors is different than another portion of the patterned reflector;

FIG. 16 is a bottom view of a diffuser such as might be positioned over the tiled light boards of FIG. 13, the diffuser comprising arrays of patterned reflectors and showing the circular asymmetry of adjacent patterned reflectors aligned over perimeter light sources of the two light boards across a gap therebetween;

FIG. 17 is a schematic view of two other patterned reflectors adjacent to each other across a gap between adjacent light board modules, the patterned reflectors showing circular diameter asymmetry;

FIG. 18 is a cross-sectional view of a portion of an exemplary backlight unit comprising two adjacent light boards tiled edge-to-edge having pattered reflectors as shown in FIG. 13 and further comprising a reflective material positioned below the gap between the light boards;

FIG. 19 is a cross-sectional view of a portion of an exemplary backlight unit comprising two adjacent light boards tiled edge-to-edge having pattered reflectors as shown in FIG. 13 and further comprising a reflective material disposed at least partially within the gap between the light boards;

FIG. 20 is another cross-sectional view of a backlight unit comprising a plurality of adjacent light board modules having a reflective material disposed at least partially in the gap between the light board modules;

FIG. 21 is a cross-sectional view of yet another embodiment of a backlight unit comprising a plurality of adjacent light board modules comprising a reflective material disposed at least partially in the gap between the light board modules and a transparent material covering the reflective material in the gap;

FIG. 22 is a cross-sectional view of still another embodiment of an exemplary display device (exploded) comprising a backlight unit with a plurality of tiled edge-to-edge light guide plates and a diffuser;

FIG. 23 is a cross-sectional view of another embodiment of an exemplary display device (exploded) comprising a backlight unit with a plurality of tiled edge-to-edge light guide plates and a diffuser, the light guide plate including a diffusive layer;

FIG. 24 is a top view of another embodiment of an exemplary display device comprising a plurality of tiled backlight units;

FIG. 25 is a cross-sectional side view of the display device of FIG. 24 as seen along line 25-25;

FIG. 26 is a cross sectional side view (exploded) of another exemplary display device comprising a plurality of tiled backlight units, each tiled backlight unit comprising a plurality of tiled light guide plates;

FIG. 27 is a cross sectional side view (exploded) of yet another exemplary display device comprising a plurality of tiled backlight units, each tiled backlight unit comprising a plurality of tiled light guide plates, each light guide plate comprising a diffusive layer;

FIG. 28 is a cross-sectional side view of still another exemplary display device (exploded) comprising a backlight unit including a patterned light guide plate and a diffuser, the patterned light guide plate bonded to light sources of the underlying light board and comprising a plurality of patterned reflectors disposed on a surface thereof;

FIG. 29 is a cross-sectional side view of an exemplary backlight unit comprising a patterned light guide plate and a plurality of tiled diffusers;

FIG. 30 is a cross-sectional side view (exploded) of an exemplary backlight unit comprising a plurality of tiled and patterned light guide plates and a diffuser overtop the tiled and patterned light guide plates;

FIG. 31 is a cross-sectional side view (exploded) of an exemplary backlight unit comprising a plurality of tiled and patterned light guide plates and a plurality of tiled diffusers overtop the tiled and patterned light guide plates;

FIG. 32 is a cross-sectional side view (exploded) of an exemplary backlight unit comprising a plurality of tiled lighting modules;

FIG. 33 is a cross-sectional side view (exploded) of the backlight unit of FIG. 30 comprising a plurality of tiled and patterned light guide plates and a reflective material positioned below the gap between the tiled and patterned light guide plates;

FIG. 34 is a cross-sectional side view of an exemplary backlight unit comprising a plurality of tiled and patterned diffusers spaced apart from an underlying light board, the diffusers spaced by a plurality of spacers between the light board and the diffusers;

FIG. 35 is a cross-sectional side view of two tiled, edge-to-edge differs showing a reflective material disposed therebetween and sealing one diffuser to the other diffuser;

FIG. 36 is a schematic representation showing the path of ambient light rays into a gap between tiled light boards, and the path of light reflected from within the gap to a viewer;

FIG. 37 is a schematic representation of intensity of the reflected light of FIG. 36 as a function of position across the tiled light boards and showing a dip in the reflected light intensity over the gap;

FIG. 38 is plot of reflected light as a function of position of FIG. 36 for various surface scattering factors σ;

FIG. 39 is a plot of the seam visibility factor (SVF) as a modeled function of the light board surface scattering factor σ;

FIG. 40 is a plot of contrast (A/I_{b}) and G/W_{FWHM} as a modeled function of substrate surface scattering factor σ for a 0° view angle;

FIG. 41 is a plot of SVF as a modeled function of substrate surface scattering factor σ for view angles of 0°, 10°, 20°, and 30° when the base surface reflectivity is 0;

FIG. 42 is a plot of SVF as a modeled function of substrate surface scattering factor σ for tiling gaps of 25 μm, 50 μm, and 100 μm when the view angle is 0 degrees;

FIG. 43 is a plot of SVF as a modeled function of reflectivity difference ΔR_{bg}=R_{b}−R_{g} between base and substrate surfaces for a scattering factor of base (e.g., support frame) and substrate (e.g., light board substrate) surfaces of 0°, 0.23°, 1.15°, and 5.73°;

FIG. 44 is a plot of SVF vs reflectivity difference between base and substrate surfaces as a modeled function of the scattering factor σ of base and substrate surfaces;

FIG. 45 is a plot of SVF as a modeled function of scattering factor difference Δσ_{bg}=σₑ−σ_{g} between base and substrate surfaces;

FIG. 46 is a plot of SVF as a modeled function of reflectivity difference ΔσRₑₛ=Rₑ−Rₛ between substrate edge and front surfaces;

FIG. 47 is a plot of SVF as a modeled function of scattering factor difference Δσ_{eg}=σₑ−σ_{g} between substrate edges and substrate front surfaces;

FIG. 48 is a plot of SVF as a modeled function of the chamfer height based on a chamfer angle of 45 degrees; and

FIGS. 49A-C are cross-sectional views of various chamfered edge profiles.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, “glass-ceramics” comprise one or more crystalline phases and an amorphous, residual glass phase. Amorphous materials and glass-ceramics may be strengthened. As used herein, the term “strengthened” may refer to a material that has been chemically strengthened, for example, through ion-exchange of larger ions for smaller ions in the surface of the substrate, as discussed below. However, other strengthening methods known in the art, for example, thermal tempering, or utilizing a mismatch of the coefficient of thermal expansion between portions of the substrate to create compressive stress and central tension regions, may be utilized to form strengthened substrates.

“Glass-ceramics” include materials produced through controlled crystallization of glass. In some embodiments, glass-ceramics have from about 1% to about 99% crystallinity. Embodiments of suitable glass-ceramics of the embodiments of the disclosure may include Li₂O—Al₂O₃—SiO₂ system (i.e., LAS-System) glass-ceramics and/or glass-ceramics that include a crystal phase including β-quartz solid solution, β-spodumene, cordierite, petalite, and/or lithium disilicate. In some embodiments, a glass-ceramic material can be formed by heating a glass-based material to form ceramic (e.g., crystalline) portions. In further embodiments, glass-ceramic materials may comprise one or more nucleating agents that can facilitate the formation of crystalline phase(s).

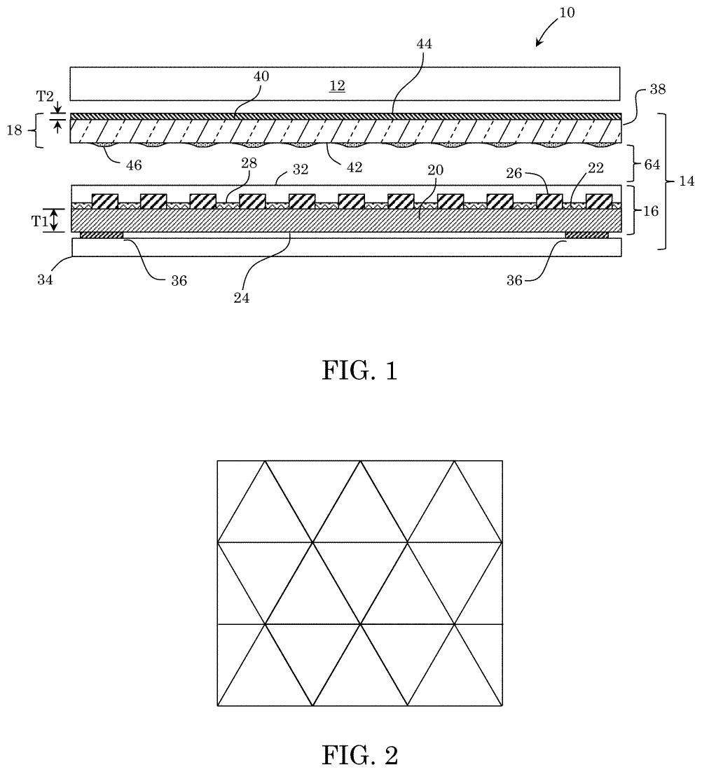

FIG. 1 is a cross-sectional side view (exploded) of an exemplary display device 10, e.g., a liquid crystal display (LCD) device, comprising a display panel 12 and a backlight unit 14. In various embodiments, backlight unit 14 can comprise a light board assembly 16 configured to illuminate display panel 12, and a diffuser 18 configured to diffuse light emitted from light board assembly 16 before illuminating display panel 12.

Light board assembly 16 comprises light board substrate 20 including a first surface 22 and a second surface 24 opposite first surface 22, first and second surfaces defining a thickness T1 therebetween. Light board assembly 16 further comprises a plurality of light sources 26 disposed on first surface 22. Light board substrate 20 may be a printed circuit board (PCB), a glass or plastic substrate, a resin substrate, a fiberglass substrate, a ceramic substrate, a glass-ceramic substrate, or any other substrate suitable for supporting light sources 26 and/or passing electrical signals to each light source 26 for individually controlling each light source. For example, light board substrate 20 may support a plurality of electrical communication lines (e.g., electrical conductors) configured to convey an electrical current to the plurality of light sources. Light board substrate 20 may be a rigid substrate or a flexible substrate. Light board substrate 20 may include a flat substrate or a curved substrate. A curved light board substrate, for example, may have a radius of curvature less than about 2000 millimeters, such as about 1500 millimeters, 1000 millimeters, 500 millimeters, 200 millimeters, or 100 millimeters.

Each light source 26 of the plurality of light sources may be, for example, an LED (e.g., size larger than about 0.5 millimeters), a mini-LED (e.g., size between about 0.1 millimeters and about 0.5 millimeters), a micro-LED (e.g., size smaller than about 0.1 millimeter), an organic LED (OLED), or another suitable light source having a wavelength ranging from about 400 nanometers to about 750 nanometers. In other embodiments, each of the plurality of light sources 26 may have a wavelength shorter than 400 nanometers and/or longer than 750 nanometers. Light sources 26 can be angularly Lambertian light sources that emit light along a Lambertian distribution pattern.

Light sources 26 can also emit light in an angular distribution different from a Lambertian distribution. For example, the angular distribution of the light emitted from light sources 26 may have a full width half maximum intensity of 90 degrees, 100 degrees, 110 degrees, 130 degrees, 140 degrees, 150 degrees, 160 degrees, larger than 160 degrees, or smaller than 90 degrees. The angular distribution may have a peak intensity along 0 degrees, 10 degrees, 20 degrees, 30 degrees, 40 degrees, 50 degrees, 60 degrees, 70 degrees, or 80 degrees, where the 0 degree direction corresponds to the normal direction of light board substrate 20.

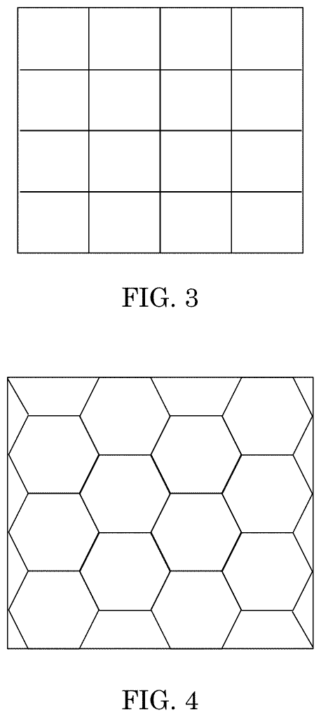

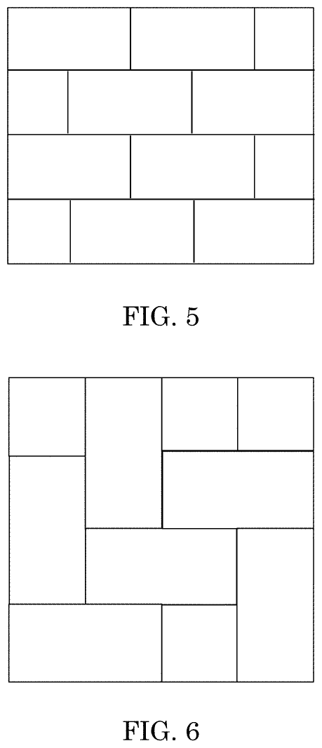

Light sources 26 may be arranged in any of a variety of array configurations on first surface 22. For example, FIGS. 2-6 represent various exemplary geometric arrangements of light sources, including without limitation a triangular array, a rectangular (e.g., square) array, a hexagonal array, a first offset rectangular array, and a second offset rectangular array, respectively. In some embodiments, light sources 26 may be arranged in any combination of two or more geometric array patterns, such as any two or more of the patterns shown in FIGS. 2-6.

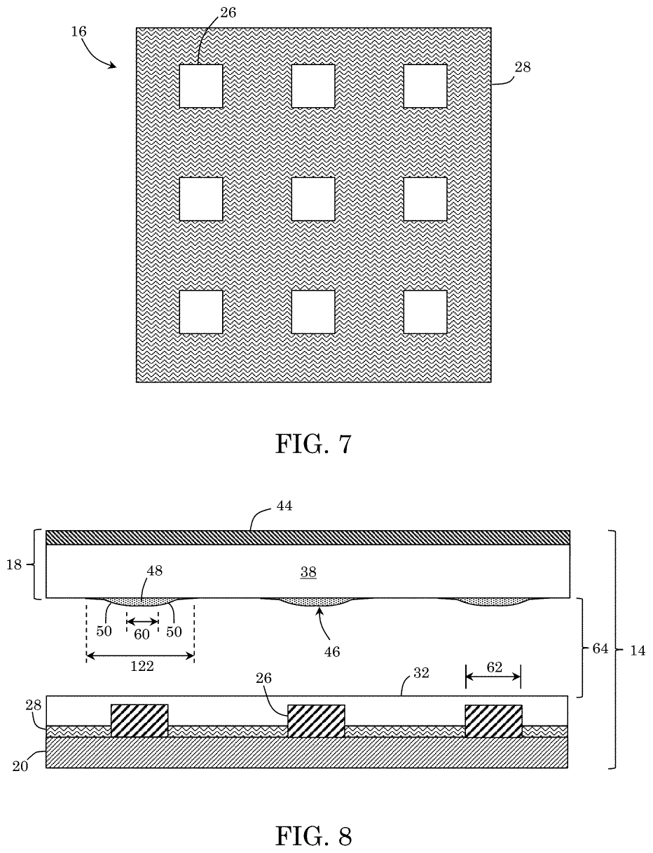

In some embodiments, light board assembly 16 may comprise a reflective layer 28 over first surface 22, reflective layer 28 surrounding light sources 26. Reflective layer 28 may be deposited on first surface 22 or positioned proximate but spaced apart from first surface 22. In some embodiments, reflective layer 28 can be bonded to first surface 22 with an adhesive. Reflective layer 28 may include, for example, metallic foils, such as silver, platinum, gold, copper, and the like; dielectric materials (e.g., polymers such as polytetrafluoroethylene (PTFE)); porous polymer materials, such as polyethylene terephthalate (PET), Poly(methyl methacrylate) (PMMA), polyethylene naphthalate (PEN), polyethersulfone (PES), etc.; multi-layer dielectric interference coatings, or reflective inks, including white inorganic particles such as titania, barium sulfate, etc., or other materials suitable for reflecting light and tuning the color of the reflected and transmitted light, such as colored pigments. A top view of light board assembly 16 showing reflective layer 28 disposed around light sources 26 is shown in FIG. 7.

In some embodiments, light board assembly 16 may further include an encapsulation layer 32 disposed over first reflective layer 28, such as a layer of protective resin that is transparent for visible light, e.g., specifically for light emitted by LEDs, encapsulation layer 32 surrounding and/or overlaying (e.g., encapsulating) light sources 26. In some embodiments, the encapsulation layer may be discrete dome-like elements (not shown) placed over corresponding light sources 26.

In various embodiments, light board assembly 16 may be mounted on (e.g., coupled to) support frame 34, for example via adhesive 36, although in further embodiments, light board assembly 16 may be coupled to support frame 34 by mechanical fasteners, e.g., screws, standoffs, or other mechanical fasteners. Support frame 34 may be, for example, a metal frame, a cabinet, or other suitable supporting member.

Diffuser 18 can comprise a carrier plate 38 comprising a first surface 40 and a second surface 42 opposite first surface 40. First surface 40 and second surface 42 may, in some embodiments, be planar, parallel surfaces. According to various embodiments, carrier plate 38 may include any suitable transparent material used for lighting and display applications. As used herein, the term “transparent” is intended to denote an optical transmission greater than about 70 percent over a length of 500 millimeters in the visible region of the spectrum (about 420-750 nanometers). In certain embodiments, an exemplary transparent material may have an optical transmittance greater than about 50 percent in the ultraviolet (UV) region (about 100-400 nanometers) over a length of 500 millimeters. According to various embodiments, carrier plate 38 may include an optical transmittance of at least 95 percent over a path length of 50 millimeters for wavelengths ranging from about 450 nanometers to about 650 nanometers. Carrier plate 38 may include scattering elements of suitable sizes to diffuse light.

Optical properties of carrier plate 38 may be affected by the refractive index of the material. According to various embodiments, carrier plate 38 may have a refractive index ranging from about 1.3 to about 1.8. In other embodiments, carrier plate 38 may have a low level of light attenuation (e.g., due to absorption and/or scattering). The light attenuation (a) of carrier plate 38 may, for example, be less than about 5 decibels per meter for wavelengths ranging from about 420-750 nanometers. Carrier plate 38 may include polymeric materials, such as plastics (e.g., polymethyl methacrylate (PMMA), methylmethacrylate styrene (MS), polydimethylsiloxane (PDMS), polycarbonate (PC)), or other similar materials. Carrier plate 38 may also include a glass material, such as aluminosilicate, alkali-aluminosilicate, borosilicate, alkali-borosilicate, aluminoborosilicate, alkali-aluminoborosilicate, soda lime, or other suitable glasses. Non-limiting examples of commercially available glasses suitable for use as a glass carrier plate include EAGLE XG®, Lotus™, Willow®, Iris™, and Gorilla® glasses from Corning Incorporated. If light board substrate 20 includes curved glass, carrier plate 38 may also include curved glass to form a curved backlight.

Diffuser 18 may further comprise a diffusive layer 44 on or over carrier plate 38, for example first surface 40. Diffusive layer 44 can face away from the plurality of light sources 26. Diffusive layer 44 may comprise one or more films positioned over or applied to first surface 40 or applied to another one or more transparent plates positioned in front of carrier plate 38, between carrier plate 38 and a viewer of the display device. Such one or more layers can include a quantum dot film, a prismatic film, a reflective polarizer, or combinations thereof, and can comprise an optical stack on or over carrier plate 38. Diffusive layer 44 can improve lateral spreading of light emitted from light sources 26, thereby improving light uniformity. Diffusive layer 44 may, for example, have specular and diffuse reflectance and specular and diffuse transmittance. The specular reflectance or transmittance is the percent of reflected or transmitted light along the specular direction with 0 or 8 degrees depending on the measurement setup, while the diffuse reflectance or transmittance is the percent of reflected or transmitted light excluding the specular reflectance or transmittance. Diffusive layer 44 may have a haze and a transmittance. The diffusive layer 44 may have a haze, for example, of about 10, 20, 30, 40, 50, 60, 70, 80, 90, 95, or 99 percent or higher, and a transmittance of about 20, 30, 40, 50, 60, 70, 80, 90, or 95 percent or higher. In certain exemplary embodiments, diffusive layer 44 may have a haze of about 70 percent and a total transmittance of about 90 percent. In other embodiments, the diffusive layer 130 may have a haze of about 88 percent and a total transmittance of about 96 percent. Haze is defined as the percent of transmitted light that is scattered so its direction deviates more than 2.5 degrees from the direction of the incident beam, and transmittance is defined as the percent of transmitted light, per American Society for Testing and Materials (ASTM) D1003 “Standard Test Method for Haze and Luminous Transmittance of Transparent Plastics.” Haze and transmittance can be measured by various haze meters.

In certain exemplary embodiments, diffusive layer 44 can include a uniform or a continuous layer of scattering particles, for example a layer of scattering particles disposed on first surface 22. Diffusive layer 44 may include a uniform layer of scattering particles where the distance between neighboring scattering particles is less than one fifth the size of a light source 26. Regardless of the location of diffusive layer 44 relative to light sources 26, diffusive layer 44 exhibits a similar diffusive property. The scattering particles may, for example, be suspended within a clear or white ink that includes micro-sized or nano-sized scattering particles, such as alumina particles, TiO₂ particles, PMMA particles, or other suitable particles. The particle size may vary, for example, within a range from about 0.1 micrometers and about 10.0 micrometers. In other embodiments, diffusive layer 44 may include an anti-glare pattern. The anti-glare pattern may be formed of a layer of polymer beads or may be etched. In this embodiment, diffusive layer 44 may have a thickness T2, for example, in a range from about 1 micrometer to about 50 micrometers, such as 3 micrometers, 7 micrometers, 14 micrometers, 21 micrometers, 28 micrometers, or another suitable thickness.

In certain exemplary embodiments, diffusive layer 44 may include a pattern that may be applied to carrier plate 38 via slot coating, screen printing, or ink jet printing. Diffusive layer 44 may be screen printed or ink jet printed on a primer layer (e.g., an adhesive layer) applied to carrier plate 38. In other embodiments, diffusive layer 44 may be applied to carrier plate 38 by laminating the diffusive layer to the carrier plate via an adhesive layer. In yet other embodiments, diffusive layer 44 may be applied to carrier plate 38 by embossing (e.g., thermal or mechanical embossing) the diffusive layer into the carrier plate, stamping (e.g., roller stamping) the diffusive layer into the carrier plate, or injection molding the diffusive layer. In still other embodiments, diffusive layer 44 may be applied to carrier plate 38 by etching (e.g., chemical etching) the carrier plate. In some embodiments, diffusive layer 44 may be applied to carrier plate 38 with a laser (e.g., laser damaging).

In other embodiments, diffusive layer 44 may include a plurality of hollow beads. The hollow beads may be plastic hollow beads or glass hollow beads. The hollow beads, for example, may be glass bubbles available from 3M Company under the trade designations “3M GLASS BUBBLES iM30K”. These glass bubbles have glass compositions including SiO₂ in a range from about 70 to about 80 percent by weight, alkaline earth metal oxide in a range from about 8 to about 15 percent by weight, and alkali metal oxide in a range from about 3 to about 8 percent by weight, and B₂O₃ in a range from about 2 to about 6 percent by weight, where each percent by weight is based on the total weight of the glass bubbles. In certain exemplary embodiments, the size (i.e., diameter) of the hollow beads may vary, for example, from about 8.6 micrometers to about 23.6 micrometers, with a median size of about 15.3 micrometers. In other embodiments, the size of the hollow beads may vary, for example, from about 30 micrometers to about 115 micrometers, with the median size of about 65 micrometers. In still other embodiments, diffusive layer 44 may include a plurality of nano-sized color conversion particles such as red and/or green quantum dots. In yet other embodiments, diffusive layer 44 may include a plurality of hollow beads, nano-sized scattering particles, and nano-sized color conversion particles such as red and/or green quantum dots.

The hollow beads may first be uniformly mixed with a solvent (e.g., Methyl Ethyl Ketone (MEK)), subsequently mixed with any suitable binder (e.g., Methyl methacrylate and silica), and then fixed by thermal or ultraviolet (UV) curing if necessary to form a paste. The paste may then be deposited onto the surface of the carrier plate 38 or other substrate plate through slot coating, screen printing, or any other suitable means to form the diffusive layer 44. In this embodiment, the diffusive layer 44 may have a thickness T2 in a range from about 10 micrometers to about 100 micrometers. In another example, the diffusive layer 44 may have a thickness between about 100 micrometers and about 300 micrometers. Multiple coatings may be used to form a thick diffusive layer if needed. In each example, the haze of the diffusive layer 44 may be more than 99 percent as measured with a haze meter such as BYK-Gardner's Haze-Gard. Two advantages of using hollow beads within diffusive layer 44 includes 1) reducing the weight of the diffusive layer 44; and 2) achieving a desired haze level at a small thickness.

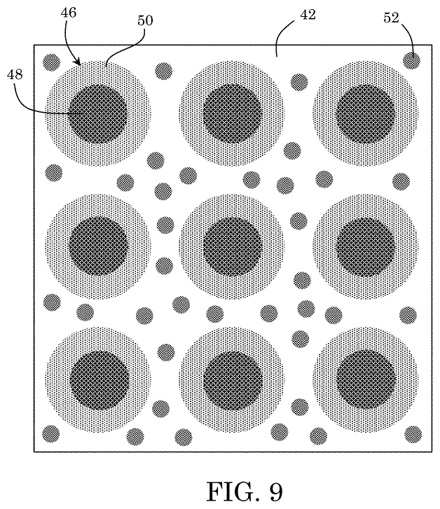

Carrier plate 38 may further include a plurality of patterned reflectors 46 arranged on a surface of the carrier plate, for example second surface 42 facing light sources 26. Referring to FIG. 8 showing a close-up cross-sectional view of a portion of backlight unit 14, each patterned reflector 46 may comprise a thickness profile including a substantially flat section 48 and a curved section 50. That is, curved section 50 represents a thickness variation of the patterned reflector. In addition, carrier plate 38 may include individual (discrete) spots 52 (see FIG. 9) in addition to patterned reflectors 46. Spots 52 can be reflective, or partially reflective and partially transmissive. The substantially flat section 48 may be more reflective than the curved section 50, and the curved section 50 may be more transmissive than the substantially flat section 48. Each curved section 50 may have properties that change in a continuous and smooth way with distance from the substantially flat section 48. In some embodiments, patterned reflectors 46 may comprise a plurality of discrete reflective dots arranged in a predetermined pattern, while in other embodiments, the discrete reflective dots may be randomly distributed. While in the embodiment illustrated in FIG. 9 each patterned reflector 46 is circular in shape, in other embodiments each patterned reflector 46 may have another suitable shape (e.g., rectangular, hexagonal, etc.). With the patterned reflectors 46 fabricated directly on second surface 42 of carrier plate 38, patterned reflectors 46 can increase the ability to hide light sources 26 from a viewer of the display device. Fabricating patterned reflectors 46 directly on second surface 42 of carrier plate 38 may also save space in a thickness direction of the display device.

In certain exemplary embodiments, each patterned reflector 46 can comprise a diffuse reflector, such that each patterned reflector 46 further enhances the performance of backlight unit 14 by scattering some light rays at sufficiently high angles that they can propagate in carrier plate 38 by total internal reflection. Such rays may then not experience multiple bounces between the patterned reflectors 46 and reflective layer 28 or between an optical film stack on diffuser 18 and the reflective layer 28 and therefore avoid loss of optical power and increase backlight unit efficiency. In certain exemplary embodiments, each patterned reflector 46 can comprise a specular reflector. In other embodiments, some areas of each patterned reflector 46 may have a more diffuse reflectivity than other areas and some areas may have a more specular reflectivity.

Each patterned reflector 46 or discrete spots 52 may be formed, for example, by printing (e.g., inkjet printing, screen printing, microprinting, etc.) a pattern with white ink, black ink, metallic ink, or other suitable ink. Spots 52 can be reflective, or partially reflective and partially transmissive. Each patterned reflector 46 or discrete spot 52 may also be formed by first depositing a continuous layer of a white or metallic material, for example by physical vapor deposition (PVD) or any number of coating techniques such as for example slot die or spray coating, and then patterning the layer by photolithography or other known methods of area-selective material removal.

In certain exemplary, where light sources 26 are white light sources, the presence of different reflective and/or absorptive materials in variable density in patterned reflectors 46 may be beneficial for minimizing color shift across dimming zones of the backlight unit. Multiple bounces of light rays between patterned reflectors 26 and reflective layer 28 may cause more loss of light in the red part of the spectrum than in the blue, or vice versa. In this case, engineering the reflection to be color neutral, for example by using slightly colored reflective and/or absorptive materials, or materials with an opposite sign of dispersion (in this case, dispersion means spectral dependence of the reflection and/or absorption) may minimize color shift.

Diffuser 18 can comprise a spatially varying transmittance or a spatially varying color shift. Since the spatial reflectance and the spatial transmittance of diffuser 18 are linked, the diffuser also comprises a spatially varying reflectance. For example, at the same location of diffuser 18, a lower (or higher) reflectance is linked to a greater (or less) transmittance. Spatially varying transmittance can be expressed in terms of a ratio of two spatial luminance distributions—one measured with the diffuser placed over a spatially uniform and angularly Lambertian light source, and the other measured with the spatially uniform and angularly Lambertian light source. The spatially varying color shift can be expressed in terms of a difference and/or ratio of two spatial color coordinate distributions—one measured with the diffuser placed over a spatially uniform and angularly Lambertian light source, and the other measured with the spatially uniform and angularly Lambertian light source.

Diffusive layer 44 diffuses light rays emitted from light sources 26. As a result, patterned reflectors 46 of backlight unit 14 may be thinner than a patterned reflector of a backlight not including diffusive layer 44 while still effectively hiding light sources 26. Diffusive layer 44 diffuses light rays that would otherwise undergo total internal reflection. In addition, diffusive layer 44 can diffuse light rays reflected back by a quantum dot film and may increase light recycling caused by such quantum dot film or prismatic films such as a brightness enhancement film (not shown) over diffuser layer 44.

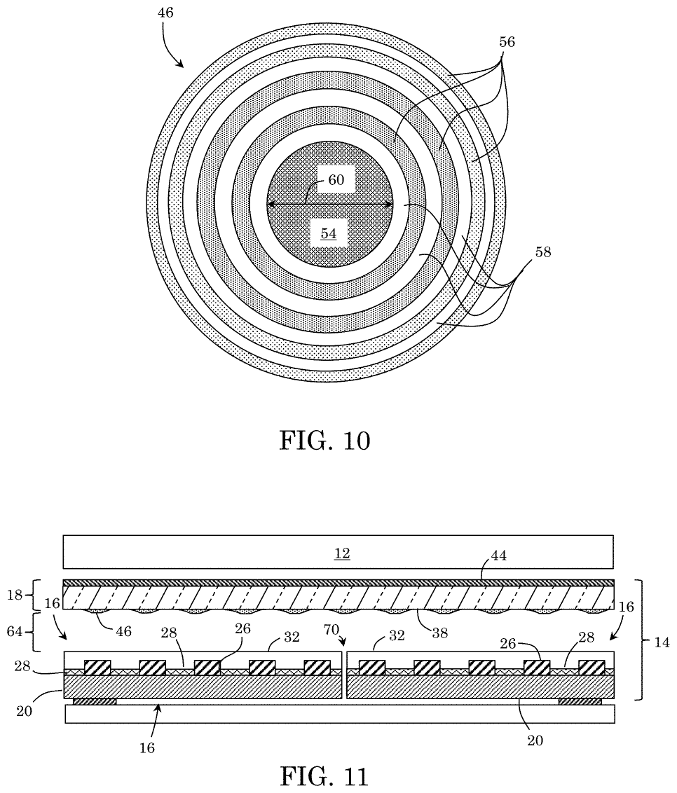

As shown in FIG. 10, in other embodiments, each patterned reflector 46 can include a first solid section 54, a plurality of second solid sections 56 surrounding the first solid section 54, and a plurality of open sections 58 interleaved with the plurality of second solid sections 56. Each second solid section 56 and each open section 58 may be ring-like, such as circular, elliptical, or another suitable shape. In various embodiments, solid sections 56 and open sections 58 may be concentric with solid section 54.

An area ratio A(r) of each second solid section 56 may equal As(r)/(As(r)+Ao(r)), where r is the distance from the center of the corresponding patterned reflector 46, As(r) is the area of the corresponding second solid section 56, and Ao(r) is the area of the corresponding open section 58. The area ratio A(r) of each second solid section 56 decreases with the distance r, and a rate of the decrease decreases with the distance r.

The size (i.e., width or diameter) of each first solid section 54 as indicated at 60 (in a plane parallel to light board substrate 20) may be greater than the size (i.e., width or diameter) of each corresponding light source 26 as indicated at 62 (in a plane parallel to light board substrate 20—see FIG. 8). The size (e.g., diameter) 60 of each first solid section 54 may be less than the size 62 of each corresponding light source 26 multiplied by a predetermined value. In certain exemplary embodiments, when the size 62 of each light source 26 is greater than or equal to about 0.5 millimeters, the predetermined value may be about two or about three, such that the size of each first solid section 54 is less than three times the size of each light source 26. When the size 62 of each light source 26 is less than about 0.5 millimeters, the predetermined value may be determined by the alignment capability between the light sources 26 and the patterned reflectors 46, such that the size of each first solid section 54 of each patterned reflector 46 is within a range between about 100 micrometers and about 300 micrometers greater than the size of each light source 26. Each first solid section 54 is large enough such that each patterned reflector 46 can be aligned to the corresponding light source 26 and small enough to achieve suitable luminance uniformity and color uniformity.

As used herein, the term “aligned” and variations as used in respect of light sources and patterned reflectors denotes a patterned reflector positioned over a particular light source and positioned such that a center of the patterned reflector lies on a line through the center of the light source light output distribution and orthogonal to the light board substrate surface to which the light source is coupled (e.g., deposited on). One or more patterned reflectors may be aligned with one or more light sources, one patterned reflector aligned to one light source. Similarly, a patterned reflector “corresponding” to a particular light source is that patterned reflector positioned over a particular light source.

Patterned reflector 46 can comprise a pattern of reflective material to create a variable diffusive reflector. The reflective material may include, for example, metallic foils, such as silver, platinum, gold, copper, and the like; dielectric materials (e.g., polymers such as PTFE); porous polymer materials, such as PET, PMMA, PEN, PES, etc., multi-layer dielectric interference coatings, or reflective inks, including white inorganic particles such as titania, barium sulfate, etc., or other materials suitable for reflecting light.

Each patterned reflector 46 may be formed, for example, by printing (e.g., inkjet printing, screen printing, microprinting, etc.) a pattern with white ink, black ink, metallic ink, or other suitable ink. Each patterned reflector 46 may also be formed by first depositing a continuous layer of a white or metallic material, for example by physical vapor deposition (PVD) or any number of coating techniques such as for example slot die or spray coating, and then patterning the layer by photolithography or other known methods of area-selective material removal.

The light from each light source 26 can be optically coupled to carrier plate 38. As used herein, the term “optically coupled” is intended to denote that a light source 26 is positioned at a surface of carrier plate 38 and is in optical communication with the carrier plate 38 directly or through an optically-clear adhesive, so as to introduce light into the carrier plate that at least partially propagates due to total internal reflection. The light from each light source 26 can be optically coupled to carrier plate 38 such that a first portion of the light can travel laterally in carrier plate 38 due to total internal reflection and can be extracted out of the carrier plate by patterned reflectors 46, and a second portion of the light can travel laterally between first reflective layer 28 and patterned reflectors 46 due to multiple reflections at the reflective surfaces of first reflective layer 28 and patterned reflectors 46 or between an optical film stack and the reflective layer 28.

In some embodiments, carrier plate 38 can be bonded to encapsulation layer 32, such as with an optically-clear adhesive or another suitable material. By bonding the carrier plate 38 to encapsulation layer 32, the overall thickness of backlight unit 14 may be reduced and/or the mechanical stability of the backlight unit may be improved. However, as shown, in other embodiments, diffuser 18 and encapsulation layer 32 may be separated by gap 64. Gap 64 may be formed, for example, by dispersing spacers (not shown) between encapsulation layer 32 and diffuser 18.

To maintain alignment between the light sources 26 and patterned reflectors 46 on carrier plate 38, carrier plate 38 and light board substrate 20 may be made of the same or similar material, such as the same or similar glass material, so that both the patterned reflectors 46 on carrier plate 38 and light sources 26 on light board substrate 20 are well-registered to each other over a large range of operating temperatures. In certain exemplary embodiments, carrier plate 38 and light board substrate 20 can be made of the same plastic material. In some embodiments, a coefficient of thermal expansion (CTE) of carrier plate 38 and a CTE of light board substrate 20 may not differ by more than 3.0×10⁻⁶/° C. However, as the size of the display panel increases, it may become difficult to maintain alignment of the patterned reflectors and the light sources, even with substantially the same CTEs.

Accordingly, in various embodiments, alignment difficulty between light sources 26 and patterned reflectors 46 can be mitigated by tiling multiple light board assemblies 16. As used herein, the terms “tiled,” “tiling,” or variations thereof refer to the side-by-side (edge-to-edge) arrangement of one or more backlight components on a common plane to produce a single, larger backlight component. For example, a single backlight unit comprising a surface area of 1000 square centimeters can be assembled using twenty 50-square-centimeter light boards arranged side-by-side. The ability to manufacture such smaller-sized light boards to the dimensional alignment requirements needed for large-size displays (e.g., greater than about 140-centimeter diagonal) is easier than attempting to align patterned reflectors on a single, 1000 square centimeter diffuser to light sources on an equal-sized light board. For example, FIG. 11 illustrates an exemplary backlight unit 14 comprising two light board assemblies 16 as previously described arranged edge-to-edge and combined with a single diffuser 18.

To further illustrate differences between the configurations of FIGS. 1 and 11, FIG. 12 is a top view of a single exemplary light board assembly 16 such as might be used in the embodiment of FIG. 1 comprising a plurality of light sources 26 arranged in a square array of orthogonal rows and columns. The light sources 26 comprise a perimeter array of light sources arranged outside dashed line 66 and proximate outer perimeter 68 of light board assembly 16 and a plurality of interior light sources within the boundary of dashed line 66 and bordered by the perimeter light sources. The pitch, defined as the center-to-center distance, between both perimeter light sources and interior light sources can be P1 in one direction or P1′ in another direction, for example, in a direction orthogonal to P1. P1 and P1′ can be equal or unequal. In comparison, FIG. 13 illustrates two light board assemblies 16 arranged on a common plane and configured edge-to-edge as depicted in FIG. 11.

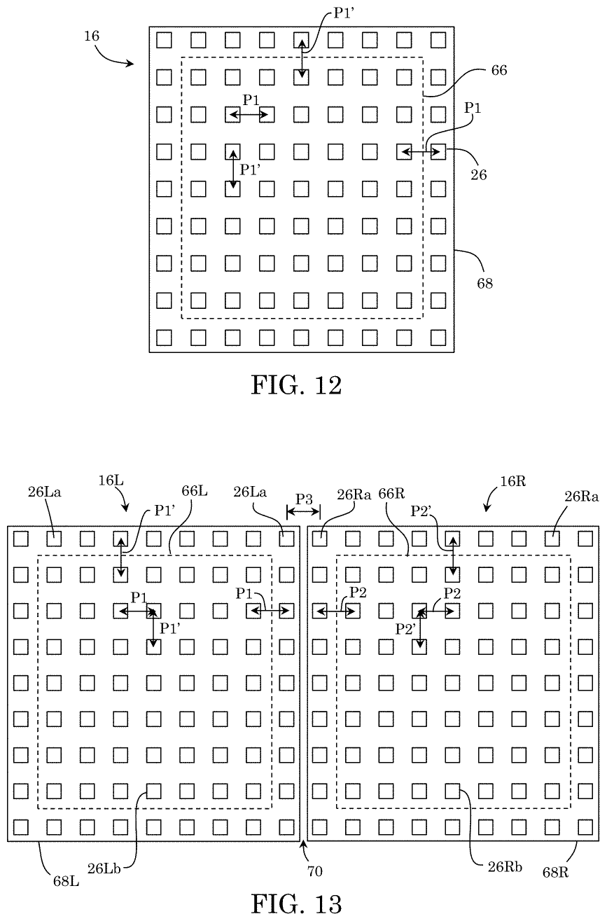

In the embodiment of FIG. 13, a first light board assembly 16L is shown on the left that is similar to the light board assembly 16 shown in FIG. 12, first light board assembly 16L comprising a plurality of light sources 26 arranged in a square array of orthogonal rows and columns. The light sources 26 comprise a perimeter array of light sources 26La arranged outside dashed line 66L and proximate outer perimeter 68L of first light board assembly 16L and a plurality of interior light sources 26Lb within the boundary of dashed line 66L. The pitch between both perimeter light sources 26La and interior light sources 26Lb of first light board assembly 16L is P1 in one direction or P1′ in another direction, for example, in a direction orthogonal to P1. On the right is a second light board assembly 16R similar to light board assembly 16 of FIG. 12 and again comprising a plurality of light sources 26 arranged in a square array of orthogonal rows and columns. Like the left-side light board assembly 16L, light sources 26 of right-side second light board assembly 16R comprise an array of perimeter light sources 26Ra arranged outside dashed line 66R and proximate outer perimeter 68R of the right-side second light board assembly 16R and a plurality of interior light sources 26Rb within the boundary defined by dashed line 66R. The pitch between both perimeter light sources 26Ra and interior light sources 26Rb of the right-side second light board assembly 16R is P2 in one direction or P2′ in another direction, for example, in a direction orthogonal to P1. P2 and P2′ can be equal or unequal. In some embodiments, P1 can be equal to P2. In some embodiments, P1′ can be equal to P2′. First light board assembly 16L and second light board assembly 16R lie on a common plane with adjacent edges (arranged edge-to-edge) of the light boards separated by gap 70. In the illustrated embodiment, gap 70 is uniform and should be as small as possible. While the arrays of light sources 26La, 26Lb, 26Ra, and 26Rb of both first and second light boards 16L and 16R may have uniform and equal pitches, the pitch between immediately-adjacent perimeter light sources 26La and 26Lb across gap 70 may differ. That is, light sources 26La along a perimeter of a first light board assembly 16L, e.g., the light sources outside dashed line 66L, may exhibit a pitch P3 relative to adjacent light sources 26Ra along a perimeter of adjacent second light board assembly 16R, outside dashed line 66R, that is different than either one or both of P1 or P2 that extend in the same direction as P3 (shown in FIG. 13 as a horizontal direction). This pitch difference across gap 70 can produce optical behavior different than the optical behavior exhibited within an interior of either one or both light board assemblies by causing an increased or decreased brightness depending on the width of the gap. Moreover, even if P3 is identical to P1 and P2, gap 70 may incur additional optical anomalies due to other factors. For example, light entering the gap between light boards may be reflected and/or refracted by surfaces within or beneath the gap that will differ from the reflection exhibited by reflective layer 28 surrounding the light sources on either one or both of the light board assemblies. This behavior may produce an optical anomaly at the gap that can be visible to a viewer of the display device. For example, a bright line, a dark line, or the gap itself, may become visible.

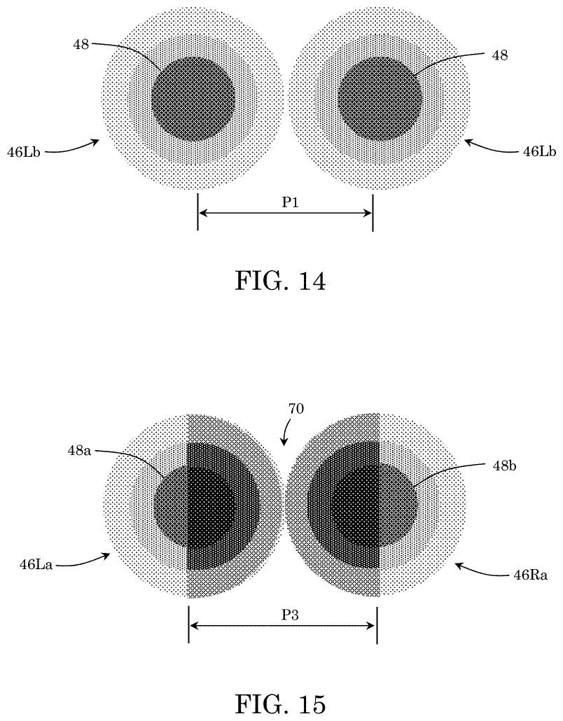

To overcome optical anomalies produced by pitch changes or other factors between light sources across gap 70, patterned reflectors 46 aligned with perimeter light sources may differ from patterned reflectors aligned with interior light sources. For example, FIG. 14 depicts two adjacent interior patterned reflectors 46Lb, aligned with two adjacent interior light sources 26Lb separated by a pitch P1 on exemplary light board assembly 16L shown in FIG. 13. The patterned reflectors, as illustrated, comprise a dense center portion that becomes radially less dense as one moves away from the center portion of the patterned reflector. For example, the patterned reflector shown in FIG. 14 may comprise discrete dots of reflective ink (e.g., white ink), wherein a spatial density of the reflective dots decreases in a direction away from the center of the reflective dot. In this instance, the patterned reflectors are most dense within a center portion (e.g., flat section 48). In the embodiment shown in FIG. 14, the density of the patterned reflectors, while varying radially, is angularly uniform, e.g., circularly symmetric.

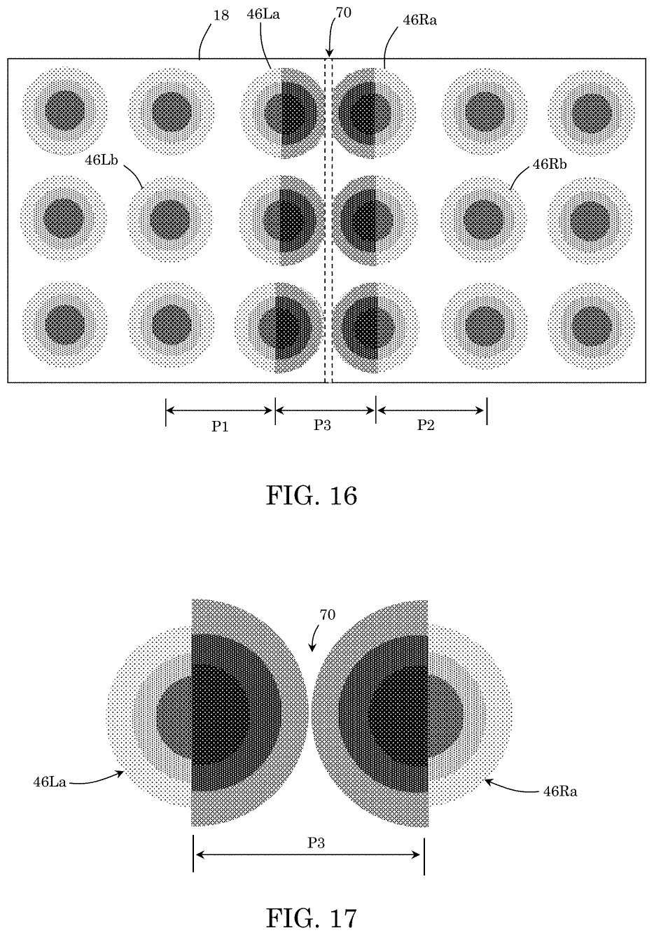

For comparison, FIG. 15 depicts two exemplary patterned reflectors, a first patterned reflector 46La aligned with a first perimeter light source 26La on first light board assembly 16L of FIG. 13 and a second patterned reflector 46Ra aligned with a second perimeter light source 26Ra on second light board assembly 16R of FIG. 13, wherein 26La and 26Ra are adjacent each other across gap 70. The separation (e.g., pitch) between first patterned reflector 46La and second patterned reflector 46Ra is the same as the pitch across gap 70 between the light sources to which the patterned reflectors are respectively aligned, i.e., P3. It can be seen that the patterned reflectors 46La and 46Ra aligned with perimeter light sources 26La and 26Ra across gap 70 in FIG. 15 have been modified compared to the patterned reflectors aligned with interior light sources shown in FIG. 14. For example, portions of patterned reflectors 46La and 46Ra closest to gap 70 shown in FIG. 15 have a greater density than other portions of the respective patterned reflectors more distant from gap 70. More specifically, both patterned reflectors 46La and 46Ra shown in FIG. 15 are no longer circularly symmetric. For example, in the embodiment of FIG. 15, one half of patterned reflector 46La comprises a first radial density profile while the second half of patterned reflector 46La comprises a second, different radial density profile. More specifically still, the right half of patterned reflector 46La, the half closest to gap 70, has a radial density profile that is greater than a radial density profile of the left half of patterned reflector 46La, the half farthest from gap 70. By density profile what is meant is the density of material comprising the patterned reflector, such as the density of reflective dots, as a function of distance along a radial line. Similarly, one half of patterned reflector 46Ra comprises a first density profile while the second half of patterned reflector 46Ra comprises a second, different density profile. More specifically, the left half of patterned reflector 46Ra, the half closest to gap 70, has a radial density profile that is greater than a density profile of the right half of patterned reflector 46Ra, the half farthest from gap 70. More simply put, the variation seen in patterned reflector 46Ra shown in FIG. 15 can be a mirror image across gap 70 of the variation seen in patterned reflector 46La. Additionally, patterned reflector 46La and patterned reflector 46Ra can comprise a first thickness profile, a first aperture opening profile, a first transmittance profile, a first reflectance profile, a first CIE x profile, or a first CIE y profile and comprise a second thickness profile, a second aperture opening profile, a second transmittance profile, a second reflectance profile, a second CIE x profile, or a second CIE y profile, respectively. FIG. 16 depicts such a scenario and illustrates a diffuser 18 comprising a first plurality of patterned reflectors 46La and a second plurality of patterned perimeter reflectors 46Ra aligned with underlying respective perimeter light sources (not shown). Gap 70 between the underlying light boards is shown as dashed lines. As shown, P3 is less than either one of P1 or P2 (in the illustrated embodiment, P2 equals P1). The plurality of patterned reflectors 46La and 46Ra are different than patterned reflectors 46Lb and 46Rb associated with interior light sources and are consistent with the scenario described in respect of FIG. 15.

By making a perimeter patterned reflector that diffuses, transmits, or reflects light differently compared to patterned reflectors aligned with interior light sources, optical anomalies at gap 70 may be managed. How that anomaly is managed can depend on the magnitude of gap 70. For example, greater light scattering can reduce additional luminance caused by a pitch P3 of light sources across gap 70 if P3 is less than P1 and/or P2. To wit, by making the radial density profile of the perimeter patterned reflectors greater proximate the gap luminance can be reduced. On the other hand, patterned reflectors aligned with perimeter light sources can be made to diffuse light more weakly if P3 is greater than P1 and/or P2. That is, the density profile of the patterned reflectors can be increased proximate the gap to counter a reduced luminance produced by a pitch P3 greater than P1 or P2.

While the foregoing description involved changes in spatial density of reflective dots as exemplified by the embodiments of FIGS. 15 and 16, other parameters of patterned reflectors may be varied to mitigate optical anomalies at gap 70 separating adjacent light boards. For example, FIG. 17 depicts a case where at least one of spatial density, size (e.g., diameter), or thickness as a function of radius of patterned reflectors aligned with perimeter light sources can be varied. Furthermore, for patterned reflectors configured as depicted in FIG. 10, the number of rings (solid and open) can be varied, as can the width of the rings. In FIG. 16, one half of both patterned reflectors 46La and 46Ra have a larger radius proximate gap 70 compared to the radius of the halves of the patterned reflectors farther from gap 70. In addition, as depicted, the radial density profile of the halves proximate gap 70 is greater than the radial density profile of the halves farthest from gap 70.

In some embodiments, the visibility of gap 70 can be reduced by positioning a reflective material below gap 70. FIG. 17 is a cross-sectional view of an exemplary backlight unit 14 comprising a reflective material 72 positioned below gap 70, for example a diffused reflective material. For example, reflective material 72 can be an adhesive strip applied to support frame 34 directly opposite and facing gap 70. Reflective material 72 can be a tape or film attached to a surface 73 of support frame 34 or could be a layer of ink. Reflective material 72 can be attached to both support frame 34 and second surface 24 of Light board assembly 16 (e.g., light board substrate 20), and therefore provide additional mechanical reinforcement of a seam between two adjacent light boards. Reflective material 72 can be achromatic, e.g., white color or reflective for light from a part or whole visible range of the visible spectrum or could have increased reflectivity in a specific range of the visible spectrum, e.g., a larger reflectivity for light with a wavelength close to the wavelength of light emitted by light source and less reflectivity in other portions of visible spectrum

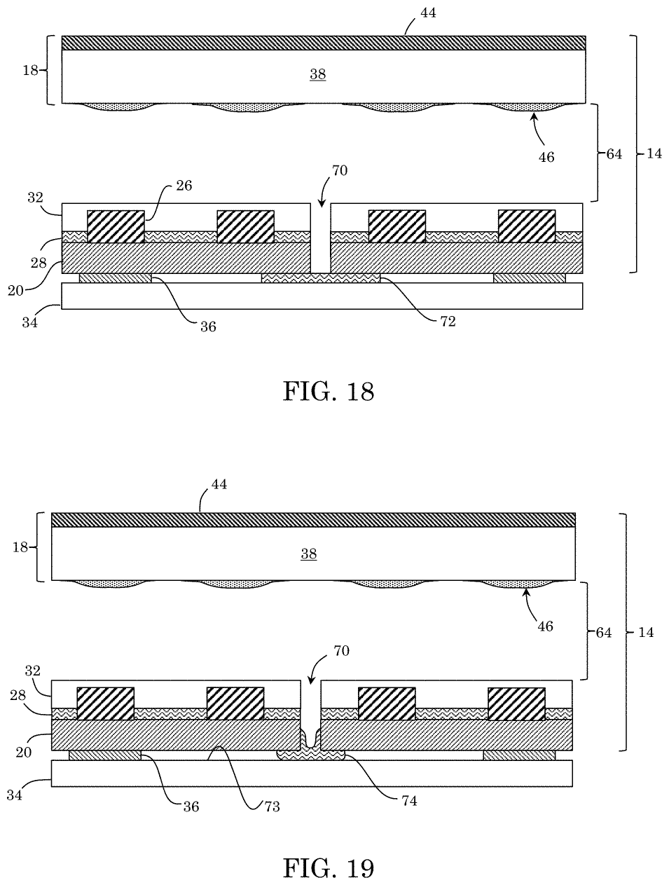

In further embodiments, the visibility of a gap between adjacent light boards can also be reduced by at least partially filling gap 70 between light board substrate 20 and reflective layer 28 with a reflective material 74 having reflective properties similar to reflective material 72, as shown in FIG. 18. Reflective material 74 can be an ink, a paint, a vulcanizing silicone or other polymerizable or solvent-based material capable of withstanding temperature cycling occurring during backlight operation. Reflective material 74 can be a diffusive reflective material. Reflective material 74 may be applied to at least a portion of respective edge portions of adjacent light board substrates 20 of adjacent light boards 16 and may, in further embodiments, be applied also to support frame 34 beneath gap 70.

In still further embodiments, reflective material 74 can be applied in a portion of gap 70, but not the entire gap, sufficient to coat all edges of the adjacent light boards and at least a portion of the surface of support frame 34, which may be exposed to light from light sources 26. Reflective material 74 can also be applied to edges of the light boards (e.g., light board substrates 20) before the light boards are assembled on support frame 34.

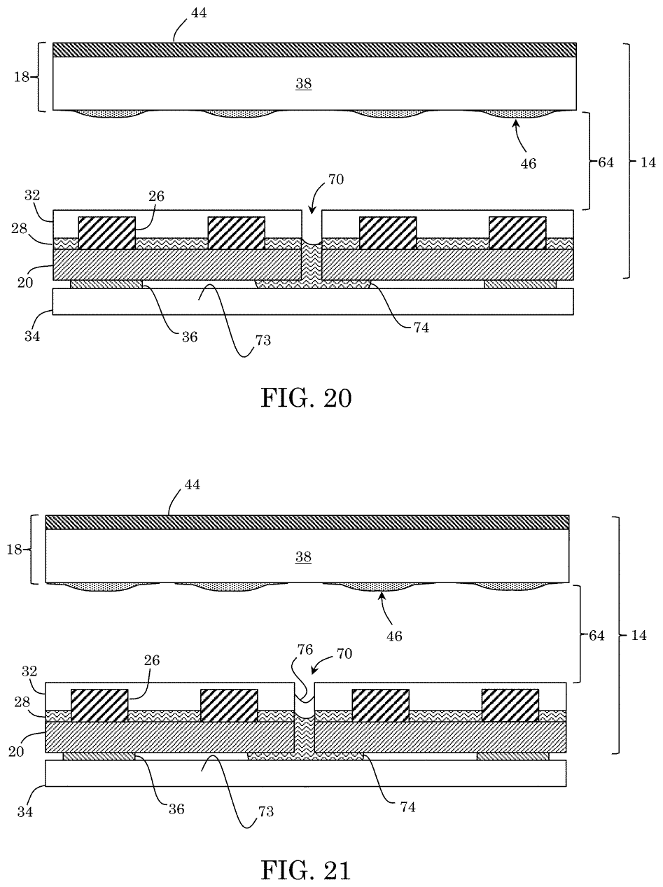

In still another embodiment, reflective material 74 may be further covered with a transparent coating 76, as show in FIG. 20. Transparent coating 76 should have good transmission in the visible spectrum, especially for light emitted by light sources 26. Transparent coating 76 can also have a refractive index similar or equal to a refractive index of encapsulating layer 32. Transparent coating 76 can be made of the same material as encapsulating layer 32. Similarly, transparent coating 76 can be used to seal gap 70 between two adjacent light boards, which is partially filled with reflective material 74.

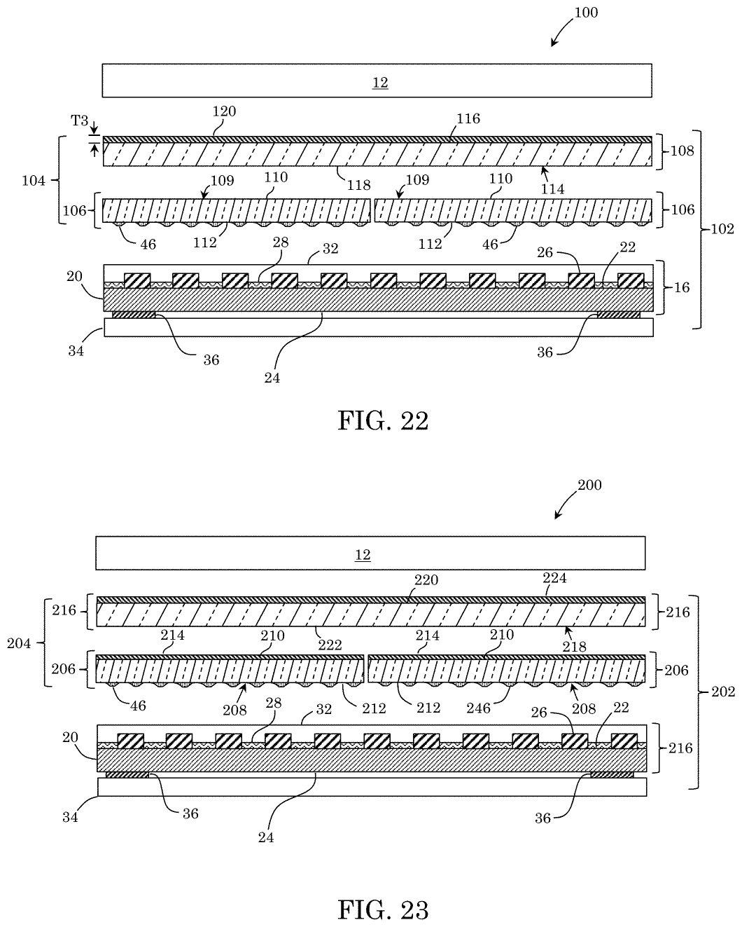

While the foregoing embodiments describe tiled light board assemblies, other components of a display device may be tiled as well. For example, in some embodiments, the display device may comprise a tiled patterned reflector plate. FIG. 22 is a cross-sectional view of an exemplary display device 100 comprising display panel 12 and a backlight unit 102. In various embodiments, backlight unit 102 can comprise light board assembly 16, the light board assembly configured to illuminate display panel 12. Backlight unit 102 may further include a diffuser 104 comprising a patterned reflector plate 106, and a diffuser plate 108 configured to diffuse light emitted from light board assembly 16 before illuminating display panel 12.

Like previous embodiments, light board assembly 16 comprises a light board substrate 20 including a first surface 22 and a second surface 24 opposite first surface 22 and may further comprise a plurality of light sources 26, for example light emitting diodes (LEDs), disposed on first surface 22. Light board substrate 20 may comprise, for example, a printed circuit board (PCB), a glass or plastic substrate, a resin substrate, a fiberglass substrate, a ceramic substrate, a glass-ceramic substrate, or another suitable substrate for passing electrical signals to each light source 26 for individually controlling each light source.

Each light source 26 of the plurality of light sources may be, for example, an LED (e.g., size larger than about 0.5 millimeters), a mini-LED (e.g., size between about 0.1 millimeters and about 0.5 millimeters), a micro-LED (e.g., size smaller than about 0.1 millimeter), an organic LED (OLED), or another suitable light source having a wavelength ranging from about 400 nanometers to about 750 nanometers. In other embodiments, each light source 26 of the plurality of light sources may have a wavelength shorter than 400 nanometers and/or longer than 750 nanometers. Light sources 26 can be angularly Lambertian light sources that emit light along a Lambertian distribution pattern.

As in previous embodiments, light board assembly 16 may be mounted on (e.g., coupled to) support frame 34, for example via adhesive 36, although in further embodiments, light board assembly 16 may be coupled to support frame 34 by mechanical fasteners, e.g., screws, standoffs, or other mechanical fasteners. Support frame 34 may be, for example, a metal frame, cabinet, or other suitable supporting member.

Diffuser 104 can comprise a plurality of patterned reflector plates 106, each patterned reflector plate 106 comprising a first carrier plate 109 comprising a first surface 110 and a second surface 112 opposite first surface 110. Patterned reflector plates 106 can be disposed on a common plane and arrayed in a pattern suitable for the display device, for example a rectangular array of rows and columns of patterned reflector plates. First surface 110 and second surface 112 may, in some embodiments, be planar, parallel surfaces. According to various embodiments, first carrier plates 109 may include any suitable transparent or diffusive material used for lighting and display applications. For example, each first carrier plate 109 can have an optical transmission greater than about 70 percent over a length of 500 millimeters in the visible region of the spectrum (about 420-750 nanometers).

The optical properties of first carrier plates 109 may be affected by the refractive index of the transparent material. According to various embodiments, the plurality of first carrier plates 109 may have a refractive index ranging from about 1.3 to about 1.8. In other embodiments, each first carrier plate 109 can have a relatively low level of light attenuation (e.g., due to absorption and/or scattering). The light attenuation (a) of first carrier plates 109 may, for example, be less than about 5 decibels per meter for wavelengths ranging from about 420-750 nanometers. First carrier plates 109 may include polymeric materials, such as plastics (e.g., polymethyl methacrylate (PMMA), methylmethacrylate styrene (MS), polydimethylsiloxane (PDMS), polycarbonate (PC)), or other similar materials. Each first carrier plate 109 may also include a glass material, such as aluminosilicate, alkali-aluminosilicate, borosilicate, alkali-borosilicate, aluminoborosilicate, alkali-aluminoborosilicate, soda lime, or other suitable glasses. Non-limiting examples of commercially available glasses suitable for use as a glass carrier plate include EAGLE XG®, Lotus™, Willow®, Iris™, and Gorilla® glasses from Corning Incorporated. If light board substrate 20 includes curved glass, first carrier plates 109 may also include curved glass to form a curved backlight.

Each first carrier plate 109 can include a plurality of patterned reflectors 46 arranged on a surface of the carrier plate, for example second surface 112. Patterned reflectors 46 can be configured as previously described. In addition, first carrier plates 109 may include individual (discrete) spots 52 (see FIG. 9) in addition to patterned reflectors 46, and may, in some embodiments, comprise a flat section 48 and a curved section 50, such as a curved central section. Spots 52 can be reflective, or partially reflective and partially transmissive. In some embodiments, the substantially flat section 48 of patterned reflectors may be more reflective than the curved section 50, and the curved section 50 may be more transmissive than the substantially flat section 48. Each curved section 50 may have properties that change in a continuous and smooth way with distance from the substantially flat section 48. In some embodiments, patterned reflectors 46 may comprise a plurality of discrete reflective dots arranged in a predetermined or random pattern. While each patterned reflector 46 can be circular in shape, in other embodiments each patterned reflector 46 may have another suitable shape (e.g., rectangular, hexagonal, etc.). In some embodiments, patterned reflectors 46 may comprise a plurality of concentric rings of reflective material surrounding a central disc. While not shown, in various embodiments, each patterned reflector plate may comprise an encapsulation layer that encapsulates the patterned reflectors 46.

As in previous embodiments, each patterned reflector 46 or discrete reflective spot 52 may be formed, for example, by printing (e.g., inkjet printing, screen printing, microprinting, etc.) a pattern with white ink, black ink, metallic ink, or other suitable ink. Each patterned reflector 46 or discrete reflective spot 52 may also be formed by first depositing a continuous layer of a white or metallic material, for example by physical vapor deposition (PVD) or any number of coating techniques such as for example slot die or spray coating, and then patterning the layer by photolithography or other known methods of area-selective material removal.

In certain exemplary embodiments, where light sources 26 are white light sources, the presence of different reflective and/or absorptive materials in variable density in patterned reflectors 46 may be beneficial for minimizing color shift across dimming zones of the backlight unit. Multiple bounces of light rays between patterned reflectors 46 and reflective layer 28 may cause more loss of light in the red part of the spectrum than in the blue, or vice versa. In this case, engineering the reflection to be color neutral, for example by using slightly colored reflective and/or absorptive materials, or materials with the opposite sign of dispersion (in this case, dispersion means spectral dependence of the reflection and/or absorption) may minimize color shift.

Diffuser 104 may further comprise a diffuser plate 108 comprising second carrier plate 114 comprising a first surface 116 and a second surface 118 opposite first surface 116. First surface 116 and second surface 118 may, in some embodiments, be planar, parallel surfaces. According to various embodiments, second carrier plate 114 may include any suitable transparent material used for lighting and display applications.

In embodiments, second carrier plate 114 may comprise a diffusive layer 120 disposed on a surface thereof, for example first surface 116. Diffusive layer 120 may face away from the plurality of light sources 26. Diffusive layer 120 can improve lateral spreading of light emitted from light sources 26, thereby improving light uniformity. Diffusive layer 120 may, for example, have specular and diffuse reflectance and specular and diffuse transmittance. Diffusive layer 120 may have a haze, for example, of about 10, 20, 30, 40, 50, 60, 70, 80, 90, 95, or 99 percent or higher, and a transmittance of about 20, 30, 40, 50, 60, 70, 80, 90, or 95 percent or higher. In certain exemplary embodiments, diffusive layer 120 may have a haze of about 70 percent and a total transmittance of about 90 percent. In other embodiments, the diffusive layer 130 may have a haze of about 88 percent and a total transmittance of about 96 percent.

In certain exemplary embodiments, diffusive layer 120 can include a uniform or continuous layer of scattering particles. Diffusive layer 120 may include a uniform layer of scattering particles where the distance between neighboring scattering particles is less than one fifth the size of the light source. Regardless of the location of diffusive layer 120 relative to the light source, diffusive layer 120 exhibits a similar diffusive property. The scattering particles may, for example, be within a clear or white ink that includes micro-sized or nano-sized scattering particles, such as alumina particles, TiO₂ particles, PMMA particles, or other suitable particles. The particle size may vary, for example, within a range from about 0.1 micrometers and about 10.0 micrometers. In other embodiments, diffusive layer 120 may include an anti-glare pattern. The anti-glare pattern may be formed of a layer of polymer beads or may be etched. In this embodiment, diffusive layer 120 may have a thickness T3, for example, in a range from about 1 micrometer to about 50 micrometers, for example 3 micrometers, 7 micrometers, 14 micrometers, 21 micrometers, 28 micrometers, including all ranges and subranges therebetween, or another suitable thickness.

In certain exemplary embodiments, diffusive layer 120 may include a pattern that may be applied to second carrier plate 114 via screen printing or ink jet printing. Diffusive layer 120 may be screen printed or ink jet printed on a primer layer (e.g., an adhesive layer) applied to the second carrier plate. In other embodiments, diffusive layer 120 may a film applied to second carrier plate 114 by laminating the diffusive layer film to the carrier plate via an adhesive layer. In yet other embodiments, diffusive layer 120 may be applied to second carrier plate 114 by embossing (e.g., thermal or mechanical embossing) the diffusive layer into the second carrier plate, stamping (e.g., roller stamping) the diffusive layer into the second carrier plate, or injection molding the diffusive layer. In still other embodiments, diffusive layer 120 may be applied to second carrier plate 114 by etching (e.g., chemical etching) the second carrier plate. In some embodiments, diffusive layer 120 may be applied to second carrier plate 114 with a laser (e.g., laser damaging).

In still other embodiments, diffusive layer 120 may include a plurality of hollow beads. The hollow beads may be plastic hollow beads or glass hollow beads. The hollow beads, for example, may be glass bubbles available from 3M Company under the trade designations “3M GLASS BUBBLES iM30K”. These glass bubbles have glass compositions including SiO₂ in a range from about 70 to about 80 percent by weight, alkaline earth metal oxide in a range from about 8 to about 15 percent by weight, and alkali metal oxide in a range from about 3 to about 8 percent by weight, and B₂O₃ in a range from about 2 to about 6 percent by weight, where each percent by weight is based on the total weight of the glass bubbles. In certain exemplary embodiments, the size (i.e., diameter) of the hollow beads may vary, for example, from about 8.6 micrometers to about 23.6 micrometers, with a median size of about 15.3 micrometers. In another embodiment, the size of the hollow beads may vary, for example, from about 30 micrometers to about 115 micrometers, with the median size of about 65 micrometers. In yet other embodiments, diffusive layer 120 may include a plurality of nano-sized color conversion particles such as red and/or green quantum dots. In still other embodiments, diffusive layer 120 may include a plurality of hollow beads, nano-sized scattering particles, and nano-sized color conversion particles such as red and/or green quantum dots.

The hollow beads may first be uniformly mixed with a solvent (e.g., Methyl Ethyl Ketone (MEK)), subsequently mixed with any suitable binder (e.g., Methyl methacrylate and silica), and then fixed by thermal or ultraviolet (UV) curing if necessary to form a paste. The paste may then be deposited onto the surface of second carrier plate 114 through slot coating, screen printing, or any other suitable means to form the diffusive layer 120. In this embodiment, diffusive layer 120 may have a thickness, for example, between about 10 micrometers and about 100 micrometers. In another example, diffusive layer 120 may have a thickness between about 100 micrometers and about 300 micrometers. Multiple coatings may be used to form a thick diffusive layer if needed. In each example, the haze of the diffusive layer 120 may be more than 99 percent as measured with a haze meter such as BYK-Gardner's Haze-Gard. Two advantages of using hollow beads within diffusive layer 44 includes 1) reducing the weight of the diffusive layer 120; and 2) achieving a desired haze level at a small thickness.

FIG. 23 is a cross-sectional view of another display device 200 comprising a backlight unit 202 including a light board assembly 16 as previously described, and a diffuser 204 comprising a patterned reflector plate 206, and a diffuser plate 216, diffuser 204 configured to diffuse light emitted from light board assembly 16 before illuminating display panel 12.

Like previous embodiments, light board assembly 16 comprises a light board substrate 20 including a first surface 22 and a second surface 24 opposite first surface 22 and may further comprise a plurality of light sources 26. Each light source 26 of the plurality of light sources may be, for example, an LED (e.g., size larger than about 0.5 millimeters), a mini-LED (e.g., size between about 0.1 millimeters and about 0.5 millimeters), a micro-LED (e.g., size smaller than about 0.1 millimeter), an organic LED (OLED), or another suitable light source having a wavelength ranging from about 400 nanometers to about 750 nanometers. In other embodiments, each of the plurality of light sources 26 may have a wavelength shorter than 400 nanometers and/or longer than 750 nanometers. Light sources 26 can be angularly Lambertian light sources that emit light along a Lambertian distribution pattern.

As in previous embodiments, light board assembly 16 may be mounted on (e.g., coupled to) support frame 34, for example via adhesive 36, although in further embodiments, light board assembly 16 may be coupled to support frame 34 by mechanical fasteners, e.g., screws, standoffs, or other mechanical fasteners. Support frame 34 may be, for example, a metal frame, cabinet, or other suitable supporting member.

Diffuser 204 can comprise a plurality of diffused and patterned reflector plates 206, each patterned reflector plate 206 comprising a transparent first carrier plate 208 comprising a first surface 210 and a second surface 212 opposite first surface 210. First surface 210 and second surface 212 may, in some embodiments, be planar, parallel surfaces. According to various embodiments, each first carrier plate 208 may include any suitable transparent material used for lighting and display applications. According to various embodiments, each first carrier plate 208 may include an optical transmittance of at least 95 percent over a path length of 50 millimeters for wavelengths ranging from about 450 nanometers to about 650 nanometers.

The optical properties of first carrier plates 208 may be affected by the refractive index of the transparent material. According to various embodiments, the plurality of first carrier plates 208 may have a refractive index ranging from about 1.3 to about 1.8. In other embodiments, each first carrier plate 208 may have a relatively low level of light attenuation (e.g., due to absorption and/or scattering). The light attenuation (a) of first carrier plates 208 may, for example, be less than about 5 decibels per meter for wavelengths ranging from about 420-750 nanometers. First carrier plates 208 may include polymeric materials, such as plastics (e.g., polymethyl methacrylate (PMMA), methylmethacrylate styrene (MS), polydimethylsiloxane (PDMS), polycarbonate (PC)), or other similar materials. First carrier plates 208 may also include a glass material, such as aluminosilicate, alkali-aluminosilicate, borosilicate, alkali-borosilicate, aluminoborosilicate, alkali-aluminoborosilicate, soda lime, or other suitable glasses. Non-limiting examples of commercially available glasses suitable for use as a glass carrier plate include EAGLE XG®, Lotus™, Willow®, Iris™, and Gorilla® glasses from Corning Incorporated. If light board substrate 20 includes curved glass, first carrier plates 208 may also include curved glass to form a curved backlight.

Each first carrier plate 208 can include a plurality of patterned reflectors 46 arranged on a surface of the carrier plate, for example second surface 212. Patterned reflectors 46 can be configured as previously described. In addition, first carrier plates 208 may include individual (discrete) spots 52 (see FIG. 9) in addition to patterned reflectors 46, and may, in some embodiments, comprise a flat section 48 and a curved section 50, such as a curved central section. Spots 52 can be reflective, or partially reflective and partially transmissive. In some embodiments, the substantially flat section 48 of patterned reflectors may be more reflective than the curved section 50, and the curved section 50 may be more transmissive than the substantially flat section 48. Each curved section 50 may have properties that change in a continuous and smooth way with distance from the substantially flat section 48. In some embodiments, patterned reflectors 46 may comprise a plurality of discrete reflective dots arranged in a predetermined or random pattern. While each patterned reflector 46 can be circular in shape, in other embodiments each patterned reflector 46 may have another suitable shape (e.g., rectangular, hexagonal, etc.). In some embodiments, patterned reflectors 46 may comprise a plurality of concentric rings of reflective material surrounding a central disc. While not shown, in various embodiments, each patterned reflector plate may comprise an encapsulation layer that encapsulates the patterned reflectors 46.

As in previous embodiments, each patterned reflector 46 or discrete reflective spot 52 may be formed, for example, by printing (e.g., inkjet printing, screen printing, microprinting, etc.) a pattern with white ink, black ink, metallic ink, or other suitable ink. Each patterned reflector 46 or discrete reflective spot 52 may also be formed by first depositing a continuous layer of a white or metallic material, for example by physical vapor deposition (PVD) or any number of coating techniques such as for example slot die or spray coating, and then patterning the layer by photolithography or other known methods of area-selective material removal.

In certain exemplary, where light sources 26 are white light sources, the presence of different reflective and/or absorptive materials in variable density in patterned reflectors 46 may be beneficial for minimizing color shift across dimming zones of the backlight unit. Multiple bounces of light rays between patterned reflectors 46 and reflective layer 28 may cause more loss of light in the red part of the spectrum than in the blue, or vice versa. In this case, engineering the reflection to be color neutral, for example by using slightly colored reflective and/or absorptive materials, or materials with the opposite sign of dispersion (in this case, dispersion means spectral dependence of the reflection and/or absorption) may minimize color shift.

First carrier plates 208 may further comprise a first diffusive layer 214 disposed on a surface thereof, for example a surface opposite patterned reflectors 46, such as first surface 210. First diffusive layer 214 may face away from the plurality of light sources 26. First diffusive layer 214 can improve lateral spreading of light emitted from light sources 26, thereby improving light uniformity. First diffusive layer 214 may, for example, have specular and diffuse reflectance and specular and diffuse transmittance. First diffusive layer 214 may have a haze, for example, of about 10, 20, 30, 40, 50, 60, 70, 80, 90, 95, or 99 percent or higher, and a transmittance of about 20, 30, 40, 50, 60, 70, 80, 90, or 95 percent or higher. In certain exemplary embodiments, first diffusive layer 214 may have a haze of about 70 percent and a total transmittance of about 90 percent. In other embodiments, first diffusive layer 214 may have a haze of about 88 percent and a total transmittance of about 96 percent.

In certain exemplary embodiments, first diffusive layer 214 can include a uniform or continuous layer of scattering particles. First diffusive layer 214 may include a uniform layer of scattering particles where the distance between neighboring scattering particles is less than one fifth the size of the light source. Regardless of the location of first diffusive layer 214 relative to the light source, first diffusive layer 214 exhibits a similar diffusive property. The scattering particles may, for example, be within a clear or white ink that includes micro-sized or nano-sized scattering particles, such as alumina particles, TiO₂ particles, PMMA particles, or other suitable particles. The particle size may vary, for example, within a range from about 0.1 micrometers and about 10.0 micrometers. In other embodiments, first diffusive layer 214 may include an anti-glare pattern. The anti-glare pattern may be formed of a layer of polymer beads or may be etched. In this embodiment, first diffusive layer 214 may have a thickness, for example, of about 1, 3, 7, 14, 21, 28, or 50 micrometers, or another suitable thickness.

In certain exemplary embodiments, first diffusive layer 214 may include a pattern that may be applied to first carrier plate 208 via screen printing. First diffusive layer 214 may be screen printed on a primer layer (e.g., an adhesive layer) applied to the second carrier plate. In other embodiments, first diffusive layer 214 may comprise a film applied to first carrier plate 208 by laminating the first diffusive layer film to first carrier plate 208 via an adhesive layer. In yet other embodiments, first diffusive layer 214 may be applied to first carrier plate 208 by embossing (e.g., thermal or mechanical embossing) the diffusive layer into the second carrier plate, stamping (e.g., roller stamping) the diffusive layer into the second carrier plate, or injection molding the diffusive layer. In yet other embodiments, first diffusive layer 214 may be applied to first carrier plate 208 by etching (e.g., chemical etching) the second carrier plate. In some embodiments, first diffusive layer 214 may be applied to first carrier plate 208 with a laser (e.g., laser damaging).

In still other embodiments, first diffusive layer 214 may include a plurality of hollow beads. The hollow beads may be plastic hollow beads or glass hollow beads. The hollow beads, for example, may be glass bubbles available from 3M Company under the trade designations “3M GLASS BUBBLES iM30K”. These glass bubbles have glass compositions including SiO₂ in a range from about 70 to about 80 percent by weight, alkaline earth metal oxide in a range from about 8 to about 15 percent by weight, and alkali metal oxide in a range from about 3 to about 8 percent by weight, and B₂O₃ in a range from about 2 to about 6 percent by weight, where each percent by weight is based on the total weight of the glass bubbles. In certain exemplary embodiments, the size (i.e., diameter) of the hollow beads may vary, for example, from about 8.6 micrometers to about 23.6 micrometers, with a median size of about 15.3 micrometers. In another embodiment, the size of the hollow beads may vary, for example, from about 30 micrometers to about 115 micrometers, with the median size of about 65 micrometers. In yet other embodiments, diffusive layer 120 may include a plurality of nano-sized color conversion particles such as red and/or green quantum dots. In yet other embodiments, first diffusive layer 214 may include a plurality of hollow beads, nano-sized scattering particles, and nano-sized color conversion particles such as red and/or green quantum dots.

The hollow beads may first be uniformly mixed with a solvent (e.g., Methyl Ethyl Ketone (MEK)), subsequently mixed with any suitable binder (e.g., Methyl methacrylate and silica), and then fixed by thermal or ultraviolet (UV) curing if necessary to form a paste. The paste may then be deposited onto the surface of first carrier plate 208 through slot coating, screen printing, or any other suitable means to form first diffusive layer 214. In this embodiment, first diffusive layer 214 may have a thickness, for example, between about 10 micrometers and about 100 micrometers. In another example, first diffusive layer 214 may have a thickness between about 100 micrometers and about 300 micrometers. Multiple coatings may be used to form a thick first diffusive layer if needed. In each example, the haze of first diffusive layer 214 may be more than 99 percent as measured with a haze meter such as BYK-Gardner's Haze-Gard. Two advantages of using hollow beads within diffusive layer 44 includes 1) reducing the weight of the diffusive layer 120; and 2) achieving a desired haze level at a small thickness.

Diffuser 204 may further comprise a diffuser plate 216 comprising second carrier plate 218 comprising a first surface 220 and a second surface 222 opposite first surface 220. First surface 220 and second surface 222 may, in some embodiments, be planar, parallel surfaces. According to various embodiments, second carrier plate 218 may include any suitable transparent material used for lighting and display applications.

In embodiments, second carrier plate 218 may comprise a second diffusive layer 224 disposed on a surface thereof, for example first surface 220. Second diffusive layer 224 may face away from the plurality of light sources 26. Second diffusive layer 224 can improve lateral spreading of light emitted from light sources 26, thereby improving light uniformity. Second diffusive layer 224 may, for example, have specular and diffuse reflectance and specular and diffuse transmittance. Second diffusive layer 224 may have a haze, for example, of about 10, 20, 30, 40, 50, 60, 70, 80, 90, 95, or 99 percent or higher, and a transmittance of about 20, 30, 40, 50, 60, 70, 80, 90, or 95 percent or higher. In certain exemplary embodiments, second diffusive layer 224 may have a haze of about 70 percent and a total transmittance of about 90 percent. In other embodiments, second diffusive layer 224 may have a haze of about 88 percent and a total transmittance of about 96 percent.

In certain exemplary embodiments, second diffusive layer 224 can include a uniform or continuous layer of scattering particles. Second diffusive layer 224 may include a uniform layer of scattering particles where the distance between neighboring scattering particles is less than one fifth the size of the light source. Regardless of the location of second diffusive layer 224 relative to the light source, second diffusive layer 224 exhibits a similar diffusive property. The scattering particles may, for example, be within a clear or white ink that includes micro-sized or nano-sized scattering particles, such as alumina particles, TiO₂ particles, PMMA particles, or other suitable particles. The particle size may vary, for example, within a range from about 0.1 micrometers and about 10.0 micrometers. In other embodiments, second diffusive layer 224 may include an anti-glare pattern. The anti-glare pattern may be formed of a layer of polymer beads or may be etched. In this embodiment, second diffusive layer 224 may have a thickness, for example, of about 1, 3, 7, 14, 21, 28, or 50 micrometers, or another suitable thickness.

In certain exemplary embodiments, second diffusive layer 224 may include a pattern that may be applied to second carrier plate 218 via screen printing. Second diffusive layer 224 may be screen printed on a primer layer (e.g., an adhesive layer) applied to the second carrier plate. In other embodiments, second diffusive layer 224 may be a film applied to second carrier plate 218 by laminating the diffusive layer film to second carrier plate 218 via an adhesive layer. In yet other embodiments, second diffusive layer 224 may be applied to second carrier plate 218 by embossing (e.g., thermal or mechanical embossing) the diffusive layer into the second carrier plate, stamping (e.g., roller stamping) the diffusive layer into the second carrier plate, or injection molding the second diffusive layer. In yet other embodiments, second diffusive layer 224 may be applied to second carrier plate 218 by etching (e.g., chemical etching) the second carrier plate. In some embodiments, second diffusive layer 224 may be applied to second carrier plate 218 with a laser (e.g., laser damaging).

In still other embodiments, second diffusive layer 224 may include a plurality of hollow beads. The hollow beads may be plastic hollow beads or glass hollow beads. The hollow beads, for example, may be glass bubbles available from 3M Company under the trade designations “3M GLASS BUBBLES iM30K”. These glass bubbles have glass compositions including SiO₂ in a range from about 70 to about 80 percent by weight, alkaline earth metal oxide in a range from about 8 to about 15 percent by weight, and alkali metal oxide in a range from about 3 to about 8 percent by weight, and B₂O₃ in a range from about 2 to about 6 percent by weight, where each percent by weight is based on the total weight of the glass bubbles. In certain exemplary embodiments, the size (i.e., diameter) of the hollow beads may vary, for example, from about 8.6 micrometers to about 23.6 micrometers, with a median size of about 15.3 micrometers. In another embodiment, the size of the hollow beads may vary, for example, from about 30 micrometers to about 115 micrometers, with the median size of about 65 micrometers. In yet other embodiments, second diffusive layer 224 may include a plurality of nano-sized color conversion particles such as red and/or green quantum dots. In yet other embodiments, second diffusive layer 224 may include a plurality of hollow beads, nano-sized scattering particles, and nano-sized color conversion particles such as red and/or green quantum dots.

The hollow beads may first be uniformly mixed with a solvent (e.g., Methyl Ethyl Ketone (MEK)), subsequently mixed with any suitable binder (e.g., Methyl methacrylate and silica), and then fixed by thermal or ultraviolet (UV) curing if necessary to form a paste. The paste may then be deposited onto the surface of second carrier plate 218 through slot coating, screen printing, or any other suitable means to form second diffusive layer 224. In this embodiment, second diffusive layer 224 may have a thickness, for example, between about 10 micrometers and about 100 micrometers. In another example, second diffusive layer 224 may have a thickness between about 100 micrometers and about 300 micrometers. Multiple coatings may be used to form a thick diffusive layer if needed. In each example, the haze of second diffusive layer 224 may be more than 99 percent as measured with a haze meter such as BYK-Gardner's Haze-Gard. Two advantages of using hollow beads within diffusive layer 44 includes 1) reducing the weight of second diffusive layer 224; and 2) achieving a desired haze level at a small thickness.

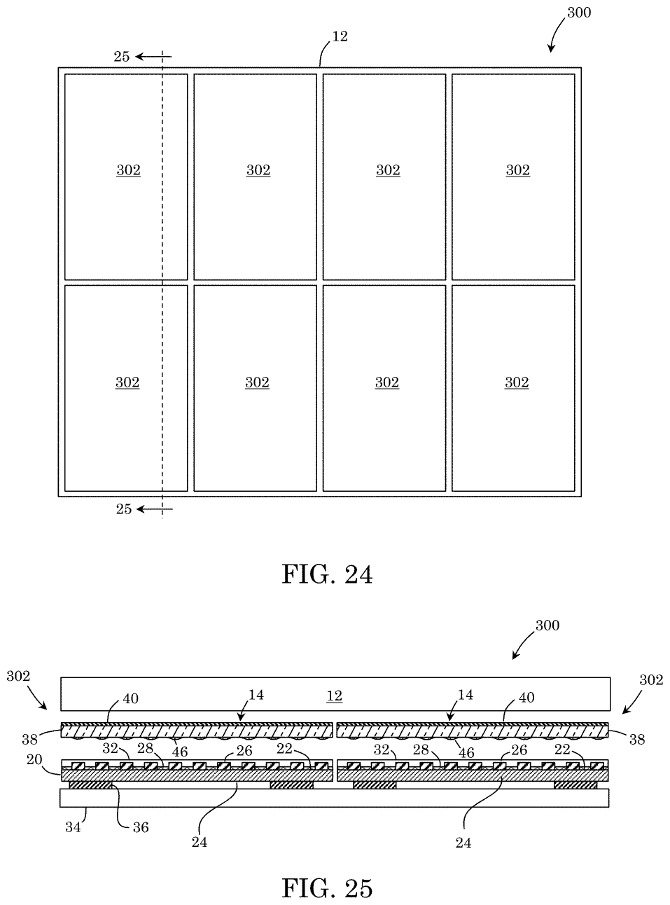

In still other embodiments, rather than individual backlight unit components, backlights can be configured as modules, tiled, and mounted to a common support frame as an array of backlight modules. By way of example, FIG. 24 is a top view of an exemplary display device 300 comprising a plurality of backlight modules 302 (e.g., backlight units 14). FIG. 25 is a cross-sectional side view of exemplary display device 300 comprising a plurality of backlight modules 302. Display device 300 comprises a display panel 12, for example an LCD panel, and a support frame 34. Each backlight module 302 can be configured, for example, as shown and described in respect of backlight unit 14 of FIGS. 1, 11, 18-21, or any other backlight disclosed herein, and the plurality of backlight modules can be coupled to support frame 34, for example by way of adhesive 36 or mechanical fasteners, as an array of backlight modules, for example a rectangular array comprising orthogonal rows and columns of backlight modules. Each backlight module 302 can comprise a light board assembly 16 as described herein comprising a plurality of light sources 26 attached to a light board substrate 20. Light board assembly 16 may further comprise a reflective layer 28 disposed on a surface of light board substrate 20. In some embodiments, light board assembly 16 may still further comprise an encapsulation layer disposed on light board substrate 20 that surrounds and covers light sources 26. Each backlight module 302 may further comprise a diffuser 18 as previously described, or any other diffuser described herein, comprising a transparent carrier plate 38 positioned between light board assembly 16 and display panel 12. Carrier plate 38 may include a plurality of patterned reflectors 46 as described herein disposed on one side of the carrier plate and a diffusive layer 44 disposed on the opposite side of the carrier plate. While not shown, carrier plate 38 may include an encapsulation layer encapsulating patterned reflectors 46.

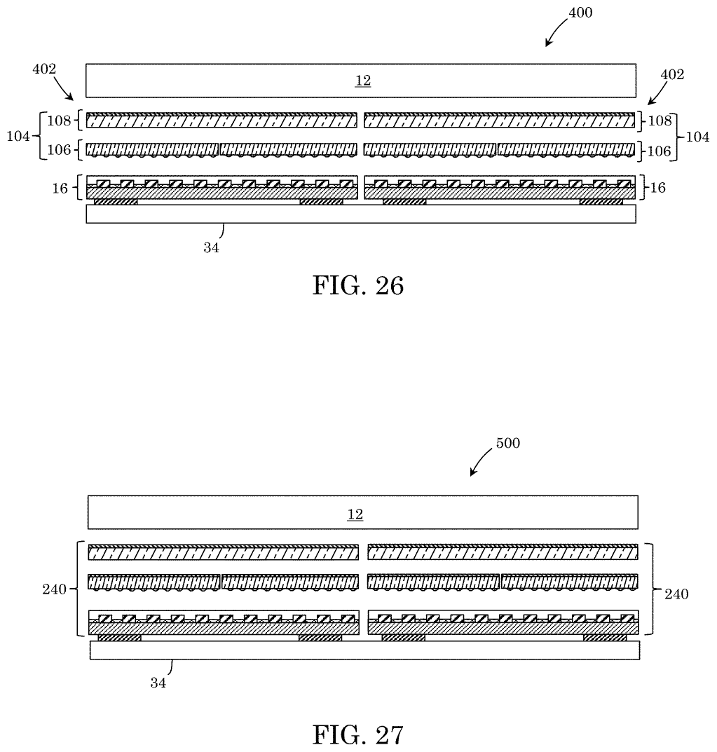

FIG. 26 is a cross-sectional side view of another exemplary display device 400 comprising a plurality of backlight modules 402. Display device 400 comprises a display panel 12, for example an LCD panel, and a support frame 34. Each backlight module 402 can be configured, for example, as shown and described in respect of backlight unit 14 of FIG. 22, and the plurality of backlight modules can be coupled to support frame 34, for example by adhesive 36 or mechanical fasteners, as an array of backlight modules, for example a rectangular array of backlight modules. Each backlight module 402 can comprise, for example, a light board assembly 16 as previously described comprising a plurality of light sources 26 attached to a light board substrate 20. Light board assembly 16 may further comprise a reflective layer 28 disposed on a first surface 22 of light board substrate 20. In some embodiments, light board assembly 16 may still further comprise an encapsulation layer 32 disposed on light board substrate 20 that surrounds and covers light sources 26.

Each backlight module 402 may further comprise a diffuser 404 comprising a plurality of patterned reflector plates 206 and a diffuser plate 216 as described herein positioned between light board assembly 16 and display panel 12. Each patterned reflector plate 206 can comprise a first carrier plate 208 including a plurality of patterned reflectors 46 as described herein disposed on one side of each first carrier plate. Each patterned reflector plate 206 may further comprise a first diffusive layer 214 as described herein disposed on a surface of first carrier plate 208 opposite patterned reflectors 46. Each backlight module 402 can comprise a second carrier plate 218 extending over the plurality of patterned reflector plates 206 of the backlight module and further comprise a second diffusive layer 224 disposed on a surface of the second carrier plate.

FIG. 27 is a cross-sectional side view of yet another exemplary display device 500 comprising a plurality of backlight modules 502. Display device 500 comprises a display panel 12, for example an LCD panel, and a support frame 34. Each backlight module 502 can be configured, for example, as shown and described in respect of backlight unit 202 of FIG. 23, and the plurality of backlight modules can be coupled to support frame 34, for example by way of adhesive 36 or mechanical fasteners, as an array of backlight modules, for example a rectangular array of backlight modules. For example, each backlight module 502 can comprise a light board assembly 16 comprising a plurality of light sources 26 attached to a light board substrate 20. Each light board assembly 16 may further comprise a reflective layer 28 disposed on a surface of light board substrate 20. In some embodiments, each light board assembly 16 may still further comprise an encapsulation layer 32 disposed on light board substrate 20 that surrounds and covers light sources 26.

Each backlight module 502 may further comprise a diffuser 504 comprising a plurality of patterned reflector plates 206 and a diffuser plate 216 as described herein positioned between light board assembly 16 and display panel 12. Each patterned reflector plate 206 can comprise a first carrier plate 208 including a plurality of patterned reflectors 46 as described herein disposed on one side of each first carrier plate. Each patterned reflector plate 206 may further comprise a first diffusive layer 214 as described herein disposed on a surface of first carrier plate 208 opposite patterned reflectors 46. Each backlight module 402 can comprise a second carrier plate 218 extending over the plurality of patterned reflector plates 206 of the backlight module and further comprise a second diffusive layer 224 disposed on a surface of the second carrier plate.

Diffuser 204 may further comprise a diffuser plate 216 comprising second carrier plate 218 extending over the plurality of patterned reflector plates 206 and further comprising a second diffusive layer 224 disposed on a surface of the second carrier plate.

In some embodiments, display devices can be made thinner by including a light guide plate between the light board assembly and the diffuser. The light guide plate directs light from the light board assembly laterally, such as through total internal reflection. Light extraction features arranged on one or more surfaces of the light guide plate can disrupt the total internal reflection and redirect light propagating in the light guide plate in a direction toward display panel 12. Lateral propagation and extraction of the light produced by the light sources helps spread the light faster, thereby allowing the display device to be made thinner. Various methods of light extraction from the light guide plate can be utilized, and while the following embodiments describe and illustrate patterned reflectors 46 and described and shown previously, other method of light extraction can be used as alternative or additional extraction mechanisms, including but not limited to volume-based light extraction features distributed within an interior of the light guide plate(s), such as particles, voids (e.g., air bubbles), and laser-induced damage such as voids or microcracks, and various surface light extraction features including surface reflectors (such as white dots), laser-induced surface features, and the like. Such light guide plates designed to guide the received light laterally and extract the light are described herein as “patterned” light guide plates. Patterned light guide plates may be combined, in various embodiments, with a diffuser to diffuse the light more broadly still.

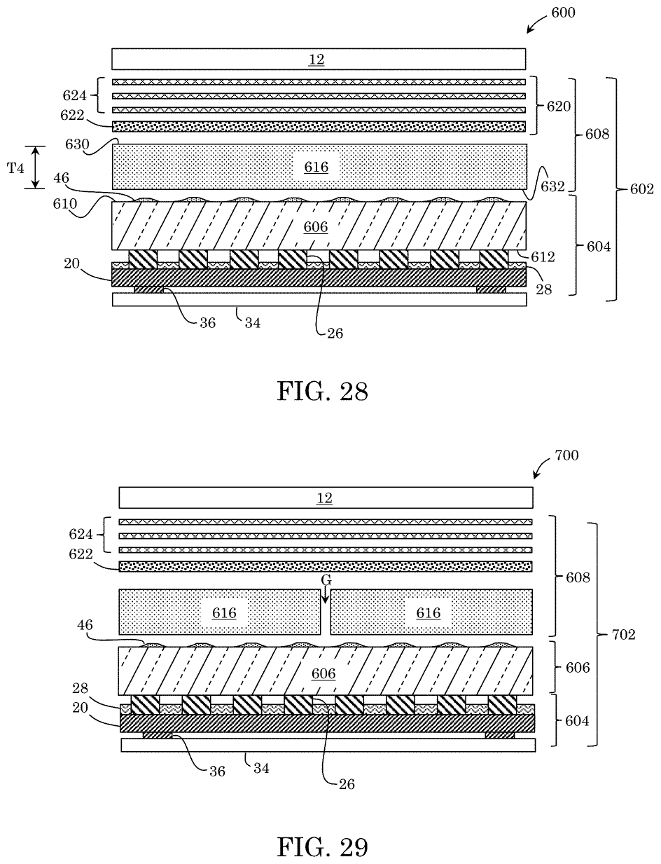

Accordingly, FIG. 28 is a cross-sectional side view of an exemplary display device 600, e.g., a liquid crystal display (LCD) device, comprising a display panel 12 and a backlight unit 602. In various embodiments, backlight unit 602 can comprise a light board assembly 604 configured to illuminate display panel 12, a patterned light guide plate 606, and a diffuser 608 configured to diffuse light emitted from patterned light guide plate 606 before illuminating display panel 12.

Light board assembly 604 can comprise a light board substrate 20 including a first surface 22 and a second surface 24 opposite first surface 22 and may further comprise a plurality of light sources 26 disposed on first surface 22. Light board substrate 20 may be a printed circuit board (PCB), a glass or plastic substrate, a resin substrate, a fiberglass substrate, a ceramic substrate, a glass-ceramic substrate, or another suitable substrate for passing electrical signals to each light source 26 for individually controlling each light source. Light board substrate 20 may be a rigid substrate or a flexible substrate. Light board substrate 20 may include a flat substrate or a curved substrate. A curved substrate, for example, may have a radius of curvature less than about 2000 millimeters, such as about 1500 millimeters, 1000 millimeters, 500 millimeters, 200 millimeters, or 100 millimeters.

Each light source 26 of the plurality of light sources may be, for example, an LED (e.g., size larger than about 0.5 millimeters), a mini-LED (e.g., size between about 0.1 millimeters and about 0.5 millimeters), a micro-LED (e.g., size smaller than about 0.1 millimeter), an organic LED (OLED), or another suitable light source having a wavelength ranging from about 400 nanometers to about 750 nanometers. In other embodiments, each of the plurality of light sources 26 may have a wavelength shorter than 400 nanometers and/or longer than 750 nanometers. Light sources 26 can be angularly Lambertian light sources that emit light along a Lambertian distribution pattern.

Light sources 26 may be arranged in any of a variety of array configurations on first surface 22, for example a two-dimensional rectangular (e.g., square) array of rows and columns, although in further embodiments, light sources 26 may be arranged in other two-dimensional geometrical arrays. For example, FIGS. 2-6 represent various exemplary geometric arrangements of light sources, including without limitation and respectively, a triangular array, a rectangular (e.g., square) array, a hexagonal array, a first offset rectangular array, and a second offset rectangular array. In some embodiments, light sources 26 may be arranged in any combination of two or more geometric array patterns, such as any two or more of the patterns shown in FIGS. 2-6.

Light board assembly 604 may still further comprise a reflective layer 28 deposited on first surface 22, reflective layer 28 surrounding light sources 26.

In various embodiments, light board assembly 604 may be mounted on (e.g., coupled to) a support frame 34, for example via adhesive 36, although in further embodiments, light board assembly 604 may be coupled to support frame 34 by mechanical fasteners, e.g., screws, standoffs, or other mechanical fasteners. Support frame 34 may be, for example, a metal frame, cabinet, or other suitable supporting member.

Light board assembly 604 may further comprise a patterned light guide plate 606 comprising a first surface 610 and a second surface 612 opposite first surface 610. First surface 610 and second surface 612 may, in some embodiments, be planar, parallel surfaces. According to various embodiments, patterned light guide plate 606 may include any suitable transparent material used for lighting and display applications.

The optical properties of patterned light guide plate 606 may be affected by the refractive index of the transparent material. According to various embodiments, patterned light guide plate 606 may have a refractive index ranging from about 1.3 to about 1.8. In other embodiments, patterned light guide plate 606 may have a low level of light attenuation (e.g., due to absorption and/or scattering). The light attenuation (a) of patterned light guide plate 606 may, for example, be less than about 5 decibels per meter for wavelengths ranging from about 420-750 nanometers. Patterned light guide plate 606 may include polymeric materials, such as plastics (e.g., polymethyl methacrylate (PMMA), methylmethacrylate styrene (MS), polydimethylsiloxane (PDMS), polycarbonate (PC)), or other similar materials. Patterned light guide plate 606 may also include a glass material, such as aluminosilicate, alkali-aluminosilicate, borosilicate, alkali-borosilicate, aluminoborosilicate, alkali-aluminoborosilicate, soda lime, or other suitable glasses. Non-limiting examples of commercially available glasses suitable for use as a glass carrier plate include EAGLE XG®, Lotus™, Willow®, Iris™, and Gorilla® glasses from Corning Incorporated. If light board substrate 20 includes curved glass, patterned light guide plate 606 may also include curved glass to form a curved backlight.

In various embodiments, patterned light guide plate 606 can comprise a plurality of patterned reflectors 46 as described herein disposed on first surface 610, although in further embodiments, patterned reflectors 46 can be disposed on second surface 612, or both first surface 610 and second surface 612. In some embodiments, patterned reflectors 46 can be as described and shown in reference to FIGS. 8-10 or FIGS. 14-17. For example, such patterned reflectors can exhibit circular or non-circular two-dimensional outlines, such as elliptical, oval, polygonal (rectangular, square, triangular), etc. Such patterned reflectors can be disc-shaped, ring-shaped, or a combination of both. In various embodiments, such patterned reflectors can comprise, for example, concentric rings. Such patterned reflectors can exhibit one or more characteristics that vary dimensionally. For example, patterned reflectors 46 can comprise a large plurality of dots, such as dots of a reflective ink (e.g., dots of white ink). Accordingly, in various embodiments, a density of the dots can vary as a function of radius (e.g., distance from a center of the patterned reflector). In some embodiments, the dot density can decrease a function of radius. In some embodiments, dot density can increase as a function of radius. In some embodiments, a thickness of the pattered reflector can vary as a function of radius. In some embodiments, dot density can vary linearly. In some embodiments, patterned reflectors 46 can comprise a central disc surrounded by a plurality of alternating transparent rings and reflective rings (e.g., rings comprising a plurality of reflective dots). In such embodiments a radial width of the transparent and/or reflective rings may vary. In some embodiments, a dot density of the reflective rings may vary as a function of radius. That is, the reflective rings may decrease in dot density from ring-to-ring. In some embodiments, one or more individual reflective rings may vary as a function of radius. In some embodiments, one or more patterned reflectors may lack circular symmetry (e.g., be circularly asymmetric) as shown and described in reference to FIGS. 15-17. In still further embodiments, patterned light guide plate 606 may comprise in addition or alternatively, other light modification features (e.g., features configured to scatter light or otherwise effect the transmission of light through the light guide plate). Such light modification features can include volume-based light extraction features distributed within an interior of the light guide plate(s), such as particles, voids (e.g., air bubbles), and laser-induced damage such as microcracks and localized refractive index variations, and various surface light extraction features including surface reflectors (such as reflective dots), laser-induced surface features, light extraction films or coatings, and the like. In various embodiments, patterned light guide plate 606 can be bonded to light sources 26. For example, second surface 612 of patterned light guide plate 606 can be bonded to light sources 26, such as with an optical adhesive, for example a transparent epoxy adhesive.

Display device 600 further comprises a diffuser 608 positioned between light board assembly 604 and display panel 12. Diffuser 608 can comprise a diffuser plate 616 comprising a first major surface 630 and a second major surface 632 opposite the first major surface 630. In some embodiments, as shown, the first major surface 630 can comprise a planar surface. In some embodiments, as shown, the second major surface 632 can comprise a planar surface. In some embodiments, as shown, the first major surface 630 can be substantially parallel to the second major surface 632. A thickness T3 of diffuser plate 616 can be defined as a distance between first major surface 630 and second major surface 632. In some embodiments, thickness T3 can be about 0.1 millimeters or more, about 0.5 millimeters or more, about 0.8 millimeters or more, about 1 millimeter or more, about 10 millimeters or less, about 8 millimeters or less, about 5 millimeters or less, about 3 millimeters or less, or about 2 millimeters or less. In some embodiments, thickness T3 can be in a range from about 0.1 millimeters to about 10 millimeters, from about 0.1 millimeters to about 8 millimeters, from about 0.5 millimeters to about 8 millimeters, from about 0.5 millimeters to about 5 millimeters, from about 0.5 millimeters to about 3 millimeters, from about 0.5 millimeters to about 2 millimeters, from about 1 millimeters to about 2 millimeters, from about 0.5 millimeters to about 10 millimeters, from about 1 millimeters to about 10 millimeters, from about 1 millimeters to about 8 millimeters, from about 1 millimeters to about 5 millimeters, from about 1 millimeters to about millimeters, including all ranges and subranges therebetween.

In some embodiments, diffuser plate 616 can comprise a polymer material. Suitable polymer materials for diffuser plate 616 can include polymethyl methacrylate (PMMA), methylmethacrylate styrene (MS), polydimethylsiloxane (PDMS), polycarbonate (PC)), or other similar materials. In some embodiments, diffuser plate 616 may comprise a glass material, such as aluminosilicate, alkali-aluminosilicate, borosilicate, alkali-borosilicate, aluminoborosilicate, alkali-aluminoborosilicate, soda lime, or other suitable glasses. Non-limiting examples of commercially available glasses suitable for use as a glass carrier plate include EAGLE XG®, Lotus™, Willow®, Iris™, and Gorilla® glasses from Corning Incorporated. In some embodiments, diffuser plate 616 can comprise a glass-ceramic material. For example, in some embodiments, the glass-ceramic material can comprise an amorphous phase and a crystalline phase comprising crystals comprising lithium disilicate and one or more of ß-spodumene or ß-quartz, the crystalline phase comprising a median grain size of one or more crystal types of the crystals in a range from about 500 nanometers to about 1,000 nanometers, the crystalline phase dispersed throughout a volume of the diffuser plate, and wherein the diffuser plate further comprises the following in mol %, SiO₂: 60-75; Al₂O₃: 2-9; Li₂O: 17-25; and Na₂O+K₂O: 0.5-6.

Diffuser 608 may further comprise optical stack 620. Optical stack 620 can include diffusing film 622 and/or image-enhancing films 624. Diffusing film 622 can comprise, for example, diffusing films from 3M™, e.g., 3635-30 or 3635-70. Image-enhancing films 624 can include optically clear plates, and/or optical films such as lenticular array films, brightness enhancing films (BEFs), quantum dot (QD) color conversion films, and the like. For example, image-enhancing films 624 can comprise one or more BEFs available from 3M™ and may include dual brightness enhancing films (DBEFs). Optical stack 620 can “recycle” light (reflecting part of the light back toward the light board assembly) and can aid in “washing out” local brightness variations produced by the tile edges or the gap between tiles. Many variations of optical stack 620 are possible.

FIG. 29 shows a cross-sectional side view of an exemplary blacklight unit 700, e.g., a liquid crystal display (LCD) device, comprising a display panel 12 and a backlight unit 702. Display device 700 is similar to display device 600 illustrated in FIG. 28 with the exception that display device 700 comprises a plurality of tiled diffuser plates 616 described and shown herein in reference to FIG. 28. The plurality of diffuser plates 616 lie on the same plate (coplanar) and are arranged edge-to-edge. In various embodiments, backlight unit 702 can comprise a light board assembly 604 configured to illuminate display panel 12, a patterned light guide plate 606, and a diffuser 608 configured to diffuse light emitted from light board assembly 604 before illuminating display panel 12

Adjacent edges of the adjacent glass diffuser plates can be polished to an optical quality to minimize the scattering on the edge surface. For example, the edge surface quality can be such that no more than about 5% of the light rays impinging on a tile edge should experience scattering at an angle greater than about 2 degrees from a normal to the edge surface at the impingement point. The other 95% of the light rays should either be transmitted or reflected at the specular condition. In some embodiments, the adjacent edges can be fire polished, for example with a laser beam or a torch, thereby healing cracks and scratches and other surface imperfections by locally re-melting the edge material. In further embodiments, the adjacent edges can be coated with an optically clear coating, for example an index-matching material, e.g., an index-matching epoxy.

Diffuser plates 616 can be positioned such that the seams (gaps) between adjacent tiles are not directly over any light sources 26 and are instead approximately in the middle between light sources, for example at edges of corresponding local dimming zones. Gaps between adjacent diffuser tiles can be invisible when the tiles are pushed closely together, but they can remain undetectable for tiles separations of up to 0.5 millimeters when optical stack 620 (e.g., a 0.1-millimeter-thick plastic diffuser film, crossed BEFs and a DBEF) is positioned over the diffuser plate. In various embodiments, a total thickness of optical stack 620 can be at least as large as gap G between adjacent diffuser plates.

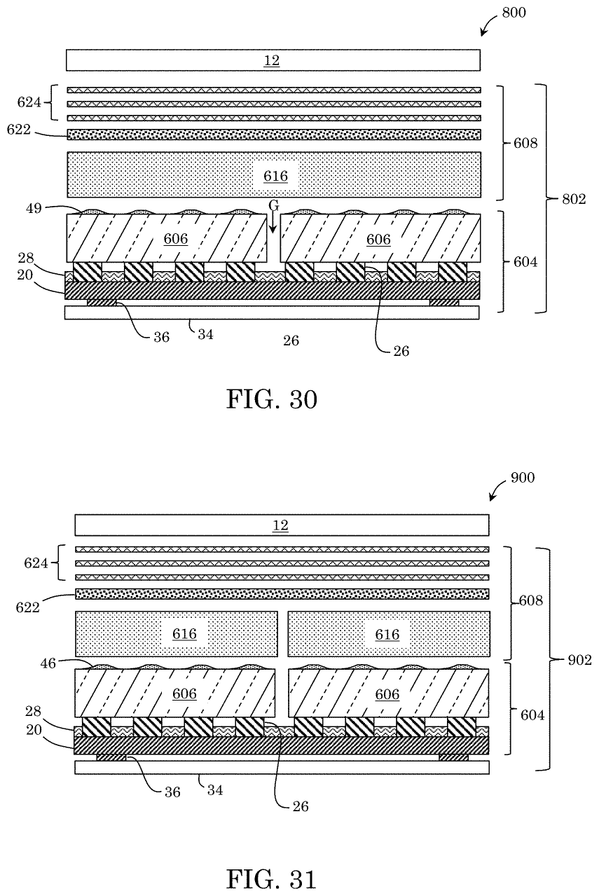

FIG. 30 shows a cross-sectional side view of an exemplary display device 800, e.g., a liquid crystal display (LCD) device, comprising a display panel 12 and a backlight unit 802. Display device 800 is similar to display device 600 illustrated in FIG. 28 with the exception that backlight unit 802 comprises a light board assembly comprising a plurality of tiled patterned light guide plates 606 described and shown herein in reference to FIG. 28. The plurality of patterned light guide plates 606 lie on a common plane and are arranged edge-to-edge. By using a plurality of small-sized light guide plates (compared to the single light guide plate employed in the embodiment of FIG. 29), alignment between patterned reflectors 46 and light sources 26 can be easier to establish and maintain. In various embodiments, backlight unit 802 can further comprise a light board assembly 604 configured to illuminate display panel 12 and a diffuser 608 configured to diffuse light emitted from light board assembly 604 before illuminating display panel 12, both light board assembly 604 and diffuser 608 as previously described.

FIG. 31 shows a cross-sectional side view of still another exemplary display device 900. Display device 900 is similar to display device 800 illustrated in FIG. 30 with the exception that in addition to backlight unit 902 comprising a plurality of tiled patterned light guide plates 606, display device 900 comprises diffuser 608 comprising a plurality of tiled diffuser plates 616. The plurality of tiled patterned light guide plates 606 lie edge-to-edge in a first predetermined array on a first common plane and the plurality of tiled diffuser plates 616 lie edge-to-edge in a second predetermined array on a second common plane.

In various embodiments, both the plurality of tiled diffuser plates and the plurality of tiled light guide plates can have the same size and shape, which can streamline fabrication. From an optics point of view, it can be beneficial if the boundaries of the diffuser tiles, and/or the light guide plates, correspond to boundaries of individual local dimming zones of the display device. In various embodiments, edges of patterned light guide plates 606 and/or diffuser plates 616, for example adjacent edges, can be polished to an optical quality to minimize scattering at the edge surfaces.

For backlight designs where accurate alignment between light sources and printed features (e.g., patterned reflectors) on the light guide plate or diffuser is required, this normally would require the light board tiles be aligned to each other. However, by providing tiled lighting modules this requirement no longer applies since small variations in individual tile positioning can be tolerated. The stress at the bonding interfaces between light board assemblies bonded to light guide plates produced by temperature variations will ordinarily be lower for smaller-sized lighting modules. In addition, module size can be “standardized” and different size backlights produced by simply using a different number of modules.

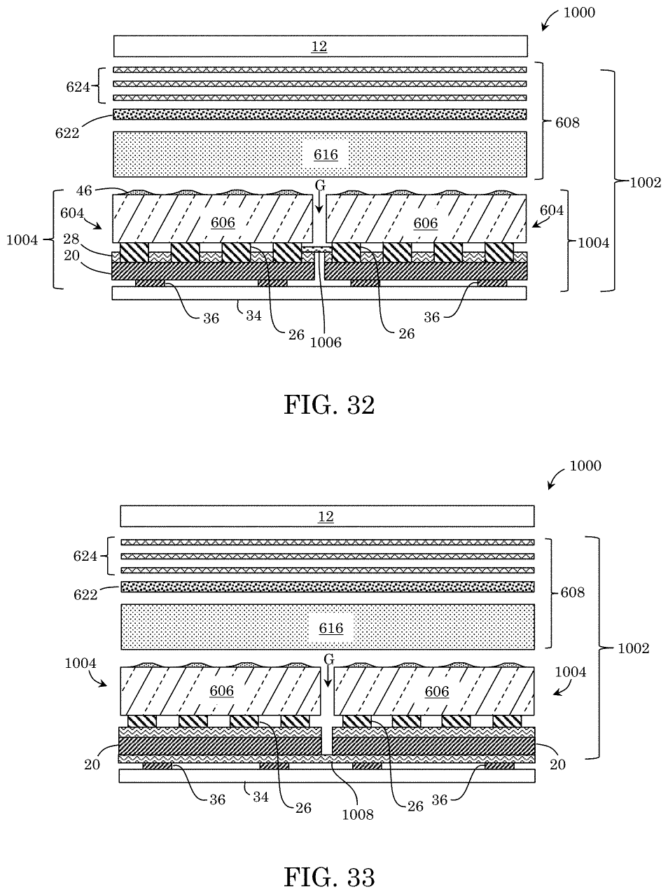

Accordingly, FIG. 32 shows a cross-sectional side view of yet another exemplary display device 1000. Display device 1000 comprises a backlight unit 1002 including a diffuser 608 as previously shown and described, and a plurality of lighting modules 1004. Each lighting module 1004 comprises a light board assembly 604 as previously shown and described. The plurality of lighting modules 1004 lie edge-to-edge on a common plane.

A challenge using the tiled modules of FIG. 32 is that gaps between adjacent lighting modules 1004 may create local brightness variations and the gaps can become visible. This visibility can be reduced to below a just-noticeable threshold, or eliminated, by employing additional mitigation. For example, FIG. 32 illustrates an optional reflective material 1006, e.g., a reflective tape, placed over the gap between the lighting modules (for example placed over the gap between adjacent light board substrates 20), or the gap may simple be painted over with a reflective paint or ink. However, this may be technologically challenging since access to the gap may be blocked by the bonded light guides. Accordingly, in further embodiments, the plurality of lighting modules 1004 can be placed on a common reflective back plate 1008, as shown in FIG. 33. Reflective back plate 1008 need only be reflective under the gaps between the plurality of lighting modules 1004, not necessarily over the entire surface of the back plate. In some embodiments, rather than a continuous reflective back plate 1008, a reflective tape or paint can be applied to the gaps, but below instead of above light board substrate 20, or both above and below. If a reflective tape is placed below light board substrate 20, it can also serve as a mounting tape to hold the light board substrate on support frame 34. In still other embodiments, reflective layer 28 can be applied as a continuous common layer overtop the upper surfaces of light board substrate 20 of all lighting modules 1004, without gaps.

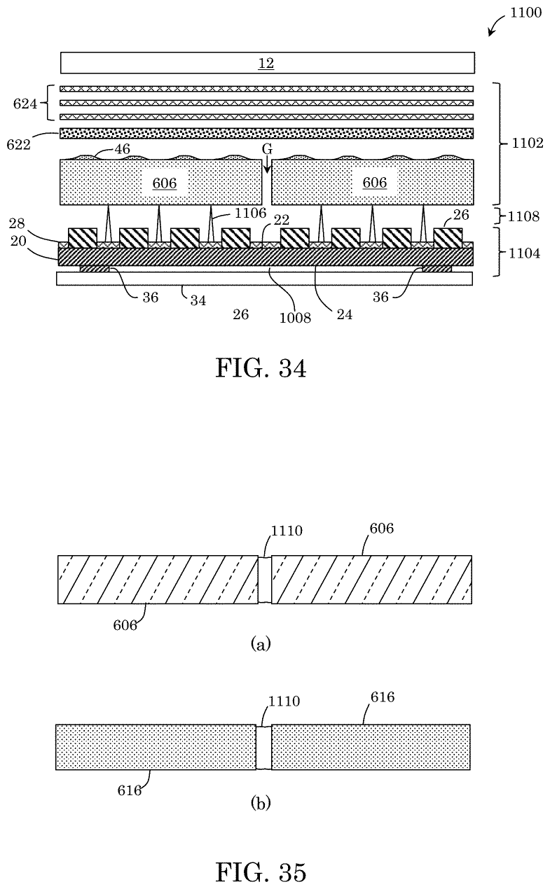

FIG. 34 shows a cross-sectional view of still another exemplary display device 1100. Display device 1100 comprises a backlight unit 1102 and a light board assembly 1104. Similar to previous embodiments, light board assembly 1104 comprises light board substrate 20 including a first surface 22 and a second surface 24 opposite first surface 22. Light board substrate 20 comprises a plurality of light sources 26 disposed thereon.

In some embodiments, diffuser plates 616 may comprise patterns on one or both major surfaces, for example patterned reflectors 46, formed by printing or other suitable means. For example, such patterns can be more reflective and less transmissive in the center of each pattern directly above the corresponding light source, and less reflective and more transmissive at the edges of the pattern, between light source locations. In this embodiment, tiled diffuser plates 616 can be spaced from light board assembly 1104 by spacers 1106, thereby producing and maintaining a uniform gap 1108. Spacers 1106 can be beads, pillars, pyramids, or any other suitable structure.

In some embodiments, as shown in FIG. 35, an index-matching material 1110, for example an index-matching adhesive (e.g., epoxy) can be used to join and/or fill tiled light guide plates (FIG. 35(a)) or diffuser plates (FIG. 35(b)) in any of the embodiments disclosed herein. Surface tension and/or capillary forces can center the index-matching material in the gap, as shown in the figure. In the case of tiled diffuser plates, an index-matched edge coating, or an index-matched gap filler may comprise light scattering particles, for example glass or silicone beads, titania powder, or air bubbles. For tiled light guide plates, the coating or filler can be optically clear. The filler may advantageously be an optical adhesive that remains soft when cured, to provide both the optical coupling between the tiles and added mechanical robustness.

Eliminating the gap between tiled components of a display device can be described from a modeling basis, wherein visibility of the gap between tiled components (also referred to as a “seam”) can be suppressed or eliminated by managing the shape of adjacent edges and reflection properties (reflectivity and scattering factor) of the edge surfaces of substrates and plates to be tiled and the surface of any underlying support structure visible between the gap between the adjacent edges. To find optimal conditions for suppressing the tiling seam visibility by above mentioned surface and edge properties, ray-tracing can be employed.

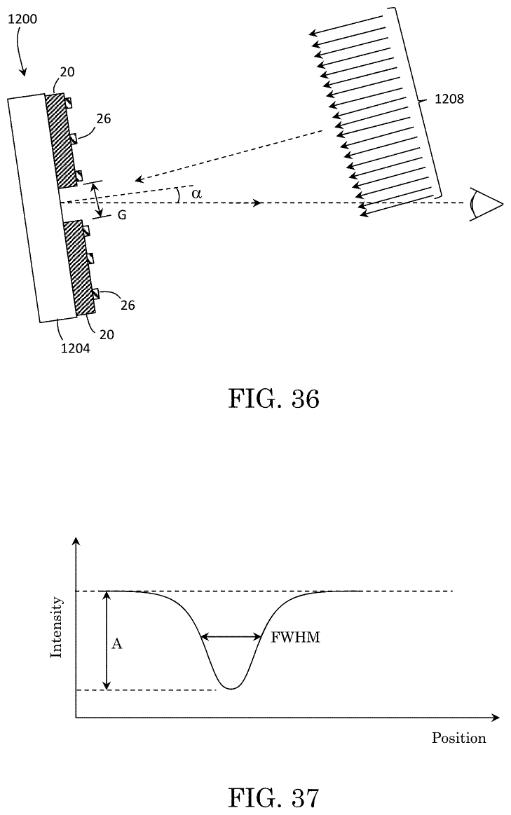

FIG. 36 is a schematic representation depicting an exemplary light board assembly 1200 1200 comprising a plurality of tiled light board substrates 1202 mounted to a back support 1204, and a plurality of light sources 26 attached to the plurality of light board substrates 20. A gap (seam) 1206 extends between the illustrated light board substrates, and an ambient light 1208 is directed toward the display device. Major parameters which can impact seam visibility are surface properties of the back support (e.g., reflectivity R_{b} and scattering factor σb), the light board substrate surface property (reflectivity R_{g} and scattering factor σ_{g}), surfaces properties of the light board substrate edges (reflectivity Rₑ and scattering factor σₑ), the shape of the light board substrate edges, the gap G between the light board substrates edges, and the view angle (α).

The light scattering property of a surface, which is related to surface roughness, can be described by a Gaussian scattering function,

$$I ( θ ) = {I}_{0} exp [ - {( \frac{θ}{σ} )}^{2} ] \qquad ( 1 )$$

where, θ is the angular difference between the actual reflected angle and the specular reflection angle, I(θ) is radiance in the θ-direction, I₀ is radiance in the specular direction, and σ is the standard deviation of the Gaussian distribution, in degrees. The specular angle, e.g., specular direction, is the ideal (mirror) reflection angle equal to the incident angle relative to a normal to the reflecting surface.

As shown in FIG. 37, to quantitatively evaluate the visibility of a seam between tiled plates, the seam visibility factor (SVF) is introduced, which is defined as,

$$SVF = ( \frac{G}{{W}_{FWHM}} ) ⨯ ( \frac{A}{{I}_{b}} ) \qquad ( 2 )$$

where G is the gap width between the two tiled substrates, W_{FWHM} is the full width at half maximum value of the gap peak of the cross-section intensity distribution of a tiled device image, A is the amplitude of the peak of the cross-section intensity distribution of a tiled device image at the seam, and I_{b} is the baseline intensity of the cross-section intensity distribution of a tiled device image.

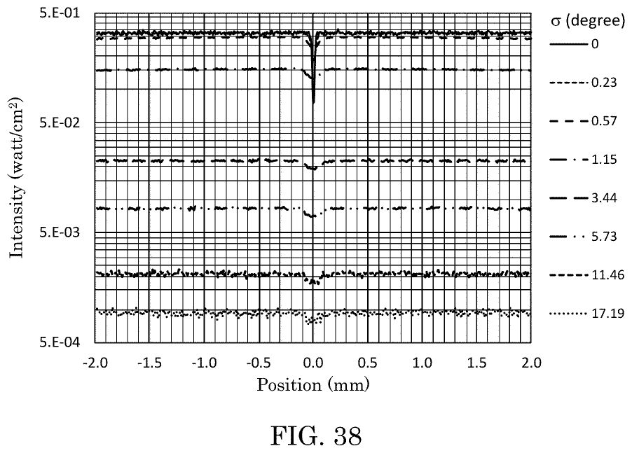

FIG. 38 shows modeled cross-sectional light intensity distributions for substrate surface scattering factor σ from 0° to 17.2° for a 0° view angle. The horizontal axis indicates position, with a zero-position indicative of the gap position between adjacent edges of tiled plates. The data reinforce the concept illustrated in the schematic view of FIG. 2 and highlights that seam visibility decreases with the increasing of substrate surface scattering factor σ.

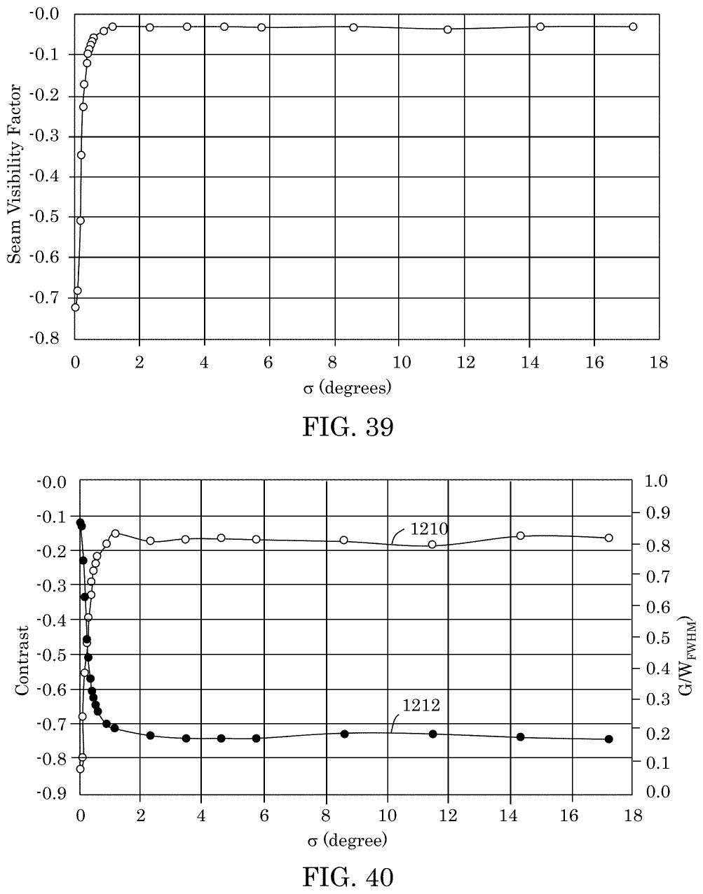

FIG. 39 is a plot of SVF and FIG. 40 are plots of contrast (A/I_{b}), curve 1210, and G/W_{FWHM}, curve 1212, the curves of both figures plotted as a function of substrate surface scattering factor σ for a 0-degree view angle α. The data show that 1) the surface scattering factor (which is relative to surface roughness) of tiled substrates has significant impact on seam visibility; 2) seam visibility (SVF) decreases with increasing substrate surface scattering factor, and the effect begins to saturate at a substrate surface scattering factor σ of about 1 degree, and; 3) seam visibility is insensitive to view angle when the reflectivity of base surface is about 0.

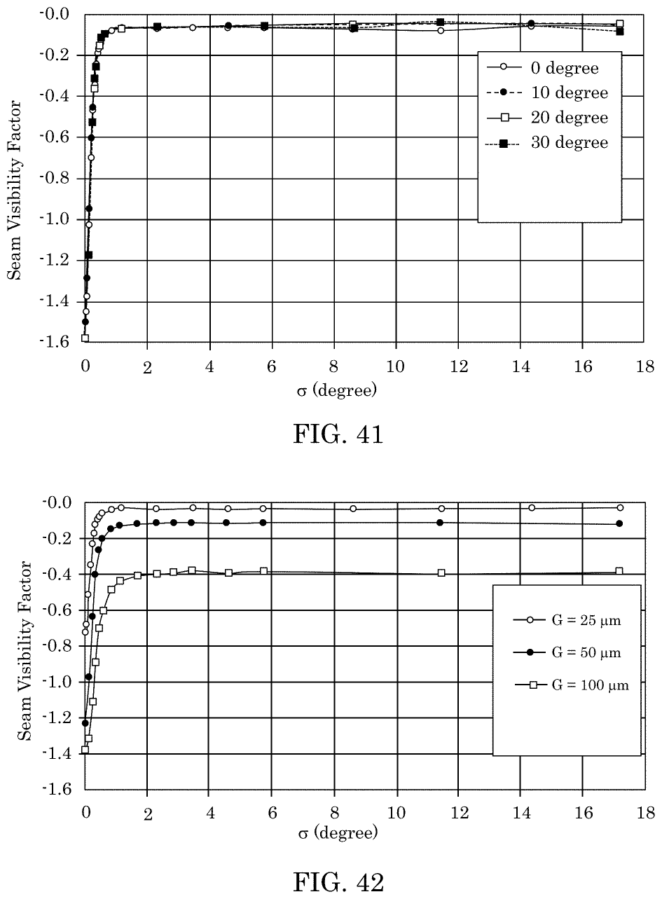

FIG. 41 shows modeled SVF as a function of substrate surface scattering factor σ for view angles of 0°, 10°, 20°, and 30° when the base surface reflectivity is 0. Good overlap of all four curves indicates tiling seam visibility is insensitive to the view angle when the base surface reflectivity is 0. FIG. 42 shows modeled SVF as a function of substrate surface scattering factor σ for tiling gaps of 25 μm, 50 μm, and 100 μm when the view angle is 0 degrees. For all three tiling gaps, seam visibility factor (SVF) increases (becomes more positive) with increasing substrate surface scattering factor σ and the effect begins to saturate at substrate surface scattering factors σ of about ˜1.0 degree, σ about 1.3 degree, and σ about 2.0 degrees for a tiling gap of 25 μm, 50 μm, 100 μm, respectively. The tiling seam visibility factor SVF decreases (becomes more negative) as the tiling gap increases.

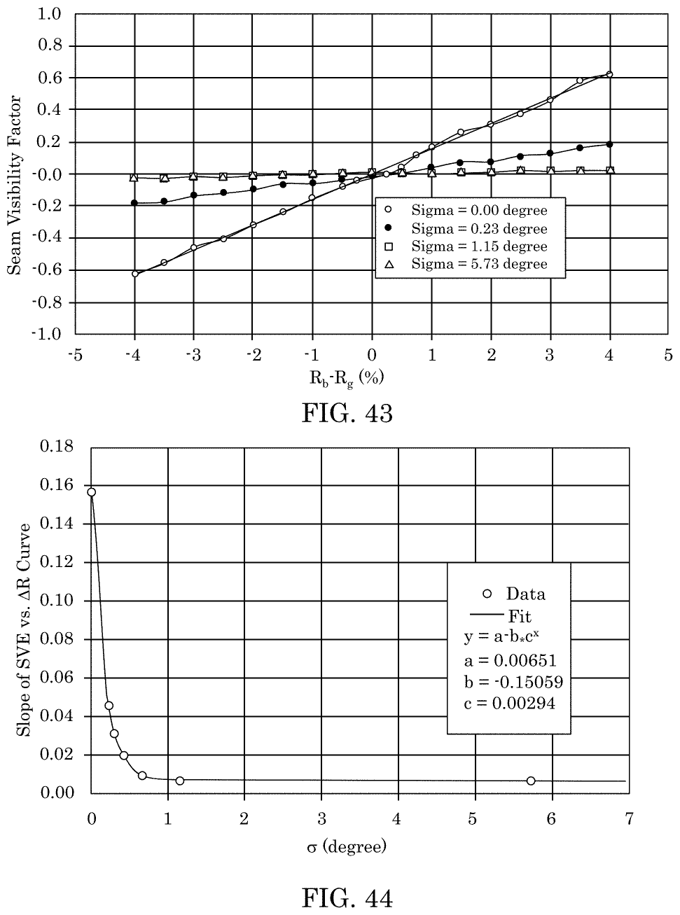

FIG. 43 shows modeled SVF as a function of reflectivity difference ΔR_{bg}=R_{b}−R_{g} between base and substrate surfaces when the scattering factor of base and substrate surfaces are 0°, 0.23°, 1.15°, and 5.73°, while FIG. 44 shows modeled SVF vs. reflectivity difference between base and substrate surfaces as a function of the scattering factor σ of the base and substrate surfaces. The sensitivity of SVF to reflectivity difference between base and substrate surfaces decreases with increasing surface scattering factors for base and substrate surfaces, and this effect begins to saturate at a surface scattering factor σ of about 1.0°.

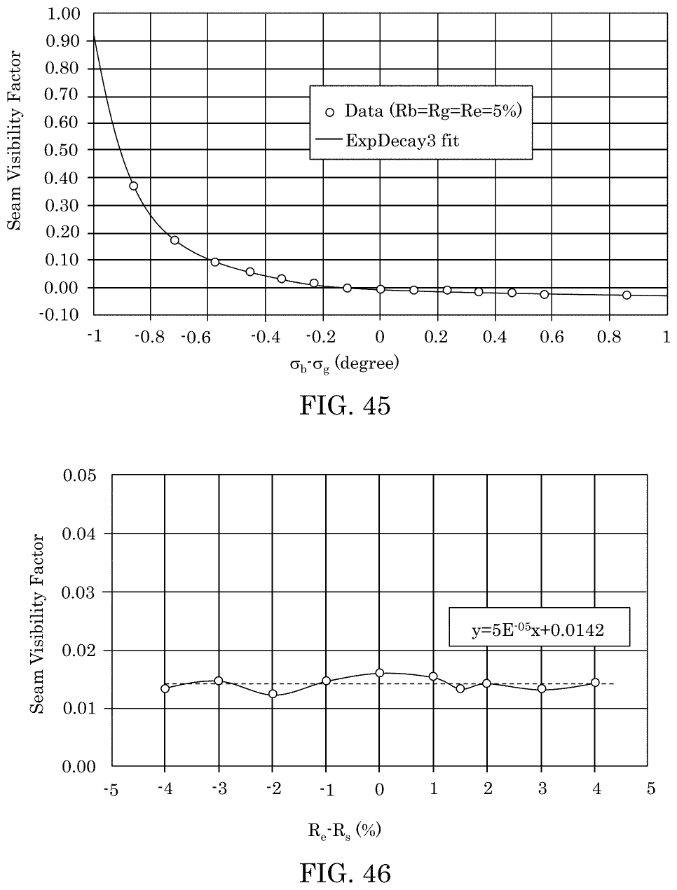

FIG. 45 shows modeled SVF as a function of scattering factor difference Δσ_{bg}=σ_{b}−σ_{g} between base and substrate surfaces. The data show that SVF exponentially decreases with scattering factor difference between base and substrate surfaces and that SVF is less sensitive to Δσ_{bg} when Δσ_{bg}>0. For examples, the range of Δσ_{bg} for achieving |SVF|<0.0243 is greater than −0.26°, the range of Δσ_{bg} for achieving |SVF|<0.01 is from −0.125° to 0.235°, and the range of Δσ_{bg} for achieving |SVF|<0.005 is from −0.06° to 0.11°. The solid curve represents an exponential decay 3 fit

FIG. 46 shows modeled SVF as a function of reflectivity difference ΔRₑₛ=Rₑ−Rₛ between substrate edge surfaces and front surfaces. The data show that SVF is not sensitive to the reflectivity difference between substrate edge and front surfaces.

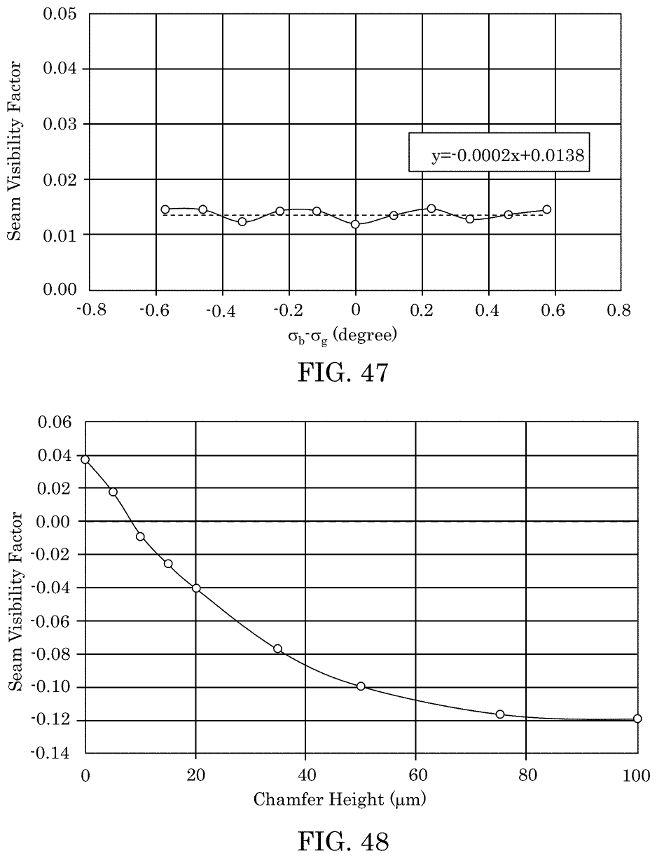

FIG. 47 shows modeled SVF as a function of scattering factor difference Δσ_{eg}=σₑ−σ_{g} between substrate edges and substrate front surfaces. The data show that seam visibility is also not sensitive to the reflectivity difference between substrate edges and front surfaces.

FIG. 48 shows modeled SVF as a function of chamfer height based on a chamfer angle of 45 degrees. When the substrate edge is chamfered, light reflected from chamfered edge surfaces is not observable by the observer due to the limited collection angle of human eyes. Therefore, SVF decreases with increasing chamfer height. Since reflectivity of the base surface R_{b}=6.5% is higher than that of the substrate surface R_{g}=5%, SVF is greater than 0 for a substrate edge without chamfer (chamfer height=0). To achieve |SVF|<0.04, the chamfer height should be less 20 μm.

The modeling has shown that:
The scattering factor of the substrate front surface σ_{g} should be greater than 1°, for example greater than about 1.3°, such as greater than about 2°;
The scattering factor of the base plate surface σ_{b} should be in a range from about 0.5σ_{g} to 1.5σ_{g}; and
The scattering factor of the substrate front surface σ_{g} should be greater than about 1 degree, for example greater than about 1.3°, such as greater than about 2°.

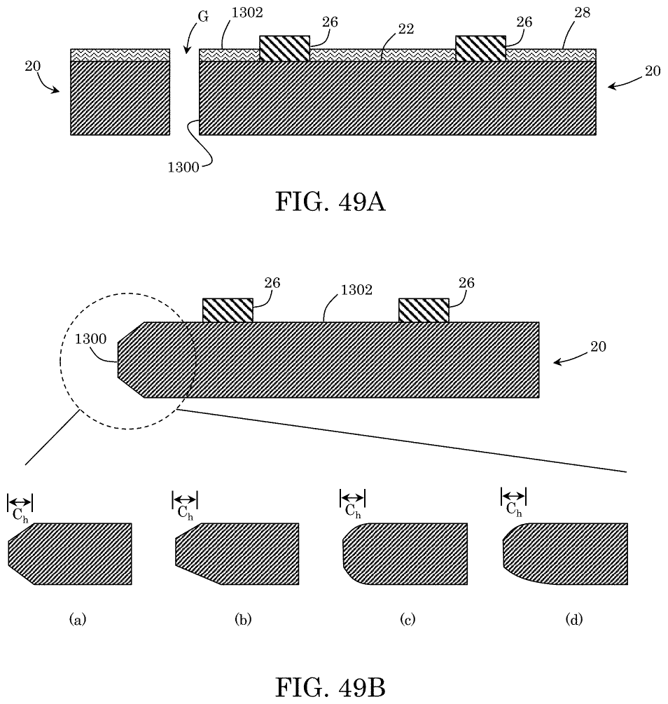

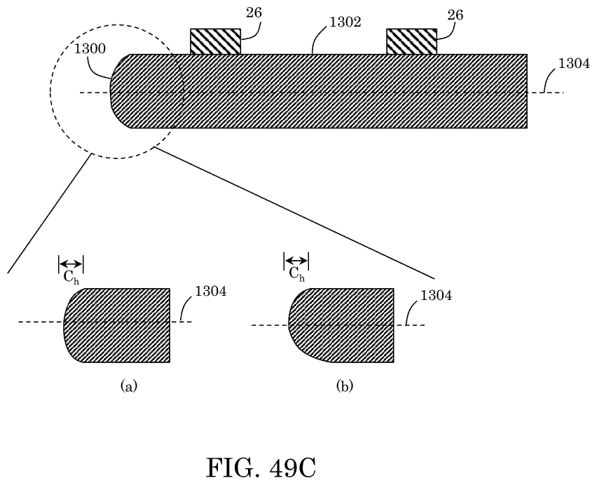

The foregoing data from FIG. 48 indicate the tiling edge of a substrate can be chamfered. FIG. 49A is a cross-sectional view of a portion of a generic light board substrate 20 according to embodiments described herein setting forth characteristics of the circuit board including tiling edge 1300 (e.g., the edge facing an adjacent edge of an adjacent light board, and the front surface 1302 of the substrate. For example, where a light board substrate 20 comprises reflective layer 28 on first surface 22, front surface 1302 is the exposed surface of reflective layer 28. Where the light board substrate does not include reflective layer 28 on first surface 22, the front surface 1302 of the light board is first surface 22.

FIGS. 49B and 49C depict in cross-section various chamfer profiles. As shown, the chamfered surface can be flat or curved, symmetrical or asymmetrical. In various embodiments, the height of the chamfer Cₕ can be less 0.5G (where G is the width of the tiling gap).

In embodiments, the tiling edge surface 1300 of the substrate can have a convex shape that can be either symmetrical or asymmetrical to the center line 1304 of the substrate. In various embodiments, the height Cₕ of the chamfer 1308 can be less than about 0.5G (where G is the tiling gap, i.e., the gap between adjacent substrates).

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A display device, comprising:
a display panel;
a backlight unit arranged adjacent the display panel, the backlight unit comprising:
a first light board assembly comprising a first plurality of light sources;
a second light board assembly arranged adjacent to and on a common plane with the first light board assembly, the second light board assembly comprising a second plurality of light sources; and
a diffuser positioned over the first light board assembly and the second light board assembly, the diffuser comprising a plurality of patterned reflectors on a surface thereof.

2. The display device of claim 1, wherein the first plurality of light sources comprises a first plurality of perimeter light sources located proximate to and along a perimeter of the first light board assembly and a first plurality of interior light sources positioned interior to the first plurality of perimeter light sources and the second plurality of light sources comprises a second plurality of perimeter light sources located proximate to and along a perimeter of the second light board assembly and a second plurality of interior light sources located interior to the second plurality of perimeter light sources, the plurality of patterned reflectors comprising a first subset of patterned reflectors aligned with corresponding light sources of the first plurality of perimeter light sources and a second subset of patterned reflectors aligned with corresponding light sources of the first plurality of interior light sources, and wherein the first subset of patterned reflectors is different from the second subset of patterned reflectors.

3. The display device of claim 2, wherein the plurality of patterned reflectors comprises a third subset of patterned reflectors aligned with corresponding light sources of the second plurality of perimeter light sources and a fourth subset of patterned reflectors aligned with corresponding light sources of the second plurality of interior light sources, and wherein the third subset of patterned reflectors is different from the fourth subset of patterned reflectors.

4. The display device of claim 3, wherein a pitch P1 between the first plurality of perimeter light sources and the first plurality of interior light sources is equal to the pitch P2 between the second plurality of perimeter light sources and the second plurality of interior light sources.

5. The display device of claim 4, wherein a pitch P3 between the first plurality of perimeter light sources and the second plurality of perimeter light sources is different from P1.

6. The display device of claim 1, wherein the first light board assembly comprises a first light board substrate and the second light board assembly comprises a second light board substrate, the first light board substrate comprising a first front surface and a first edge surface and the second light board substrate comprising a second front surface and a second edge surface adjacent to and spaced apart from the first edge surface by a gap, the display device further comprising a reflective material disposed on the first and second front surfaces and across the gap.

7. The display device of claim 6, wherein each of the first front surface and the second front surface comprises a reflective layer and the reflective material is disposed over the reflective layer.

8. The display device of claim 1, wherein the first light board assembly comprises a first light board substrate and the second light board assembly comprises a second light board substrate, the first light board substrate comprising a first back surface and a first edge surface and the second light board substrate comprising a second back surface and a second edge surface adjacent to and spaced apart from the first edge surface by a gap, the display device further comprising a reflective material disposed on the first and second back surfaces and across the gap.

9. The display device of claim 1, wherein the first and second light board assemblies are coupled to a back frame, the display device further comprising a reflective material positioned between the back frame and the first and second light board assemblies.

10. The display device of claim 1, wherein a reflective material is disposed in and at least partially filling a gap between the first light board assembly and the second light board assembly.

11. The display device of claim 10, wherein a transparent coating is disposed on the reflective material.

12. The display device of claim 1, wherein the diffuser comprises a carrier plate comprising a first surface and a second surface opposite the first surface, the second surface facing the light sources, the first and second pluralities of patterned reflectors located on at least one of the first surface of the carrier plate or the second surface of the carrier plate.

13. The display device of claim 12, wherein the diffuser further comprises a diffusive layer on the opposite one of the first surface of the carrier plate or the second surface the carrier plate.

14. The display device of claim 12, wherein the first light board assembly comprises a first light board substrate, and a CTE of the carrier plate and a CTE of the first light board substrate do not differ by more than 3.0×10⁻⁶PC.

15. The display device of claim 12, wherein the second light board assembly comprises a second light board substrate, and a CTE of the carrier plate and a CTE of the second light board substrate do not differ by more than 3.0×10⁻⁶/° C.

16. The display device of claim 1, wherein a first half of each of the first subset of patterned reflectors is different from a second half of each of the first subset of patterned reflectors.

17. The display device of claim 1, wherein a first half of each of the first subset of patterned reflectors is the same as a second half of each of the first subset of patterned reflectors.

18. The display device of claim 1, wherein the first light board assembly comprises a first light board substrate with a first edge surface and the second light board assembly comprises a second light board substrate with a second edge surface adjacent to and facing the first edge surface, the first edge surface comprising a first chamfer with a first chamfer height Ch1 and a second chamfer with a second chamfer height Ch2, the second chamfer opposite the first chamfer.

19. The display device of claim 18, where the first and second chamfers are asymmetric relative to a central plane of the first light board substrate.

20. The display device of claim 18, wherein at least one of the first chamfer or the second chamfer comprises a curvature.

21.-91. (canceled)
